(19) United States
(12) Patent Application Publication
(10) Pub. No.: US 2022/0164425 A1
(43) Pub. Date: May 26, 2022

(54) DATA PROCESSING METHOD, APPARATUS, STORAGE MEDIUM, AND DEVICE

(71) Applicant: TENCENT TECHNOLOGY (SHENZHEN) COMPANY LIMITED, Shenzhen (CN)

(72) Inventor: Junhuan ZHANGLI, Shenzhen (CN)

(21) Appl. No.: 17/667,337

(22) Filed: Feb. 8, 2022

Related U.S. Application Data
(63) Continuation of application No. PCT/CN2020/124724, filed on Oct. 29, 2020.

(30) Foreign Application Priority Data
Jan. 14, 2020 (CN) 202010037386.9

(51) Int. Cl. G06F 21/31; G06F 21/60; G06F 21/62; G06F 21/52

(52) U.S. Cl. CPC G06F 21/316; G06F 21/604; G06F 2221/2141; G06F 21/52; G06F 2221/032; G06F 21/629

(57) ABSTRACT

A data processing method includes: acquiring access users associated with at least two content display platforms, the at least two content display platforms being configured to provide business contents to the access users; generating access user overlapping degrees between pairs of content display platforms in the at least two content display platforms according to the access users; determining abnormally accessed content display platforms from the at least two content display platforms according to the access user overlapping degrees and regarding the determined abnormally accessed content display platforms; and determining abnormal access users from target access users belonging to the target content display platforms.

### CROSS-REFERENCES TO RELATED APPLICATIONS

This application is a continuation application of PCT Patent Application No. PCT/CN2020/124724, entitled “DATA PROCESSING METHOD AND APPARATUS, STORAGE MEDIUM, AND DEVICE” and filed on Oct. 29, 2020, which claims priority to Chinese Patent Application No. 202010037386.9, entitled “DATA PROCESSING METHOD, APPARATUS, STORAGE MEDIUM, AND DEVICE” filed on Jan. 14, 2020, the entire contents of both of which are incorporated herein by reference.

### FIELD OF THE TECHNOLOGY

The present disclosure relates to the field of Internet technologies, and in particular, to a data processing method, apparatus, storage medium, and device.

### BACKGROUND OF THE DISCLOSURE

With the development of Internet technologies, increasingly more merchants choose to promote commodities or services through content display platforms. A content display platform refers to a platform used for displaying a business content. The business content may include commodity information (such as a name and a type) corresponding to a commodity that a merchant needs to promote, or service information (such as a service content) corresponding to a service that needs to be promoted. In practice, it is found that a content display platform may create a large number of abnormal users (such as fake users) to access a business content displayed on the content display platform in order to increase the access amount of the content display platform. At present, abnormal access users are generally identified by analyzing access behaviors of each access user. However, abnormal access users may imitate access behaviors of normal access users, which leads to misidentification of abnormal access users as normal access users, thus reducing the accuracy of identifying abnormal access users.

### SUMMARY

The technical problem to be solved by embodiments of the present disclosure is providing a data processing method, apparatus, storage medium, and device, which can improve the accuracy of identifying abnormal access users.

In one aspect of the embodiments of the present disclosure, a data processing method is provided, including: acquiring access users associated with at least two content display platforms, the at least two content display platforms being configured to provide business contents to the access users; generating access user overlapping degrees between pairs of content display platforms in the at least two content display platforms according to the access users; determining abnormally accessed content display platforms from the at least two content display platforms according to the access user overlapping degrees and regarding the determined abnormally accessed content display platforms; and determining abnormal access users from target access users belonging to the target content display platforms.

In one aspect of the embodiments of the present disclosure, a data processing apparatus is provided, including: an acquisition module configured to acquire access users associated with at least two content display platforms, the at least two content display platforms being configured to provide business contents to the access users; a generation module configured to generate access user overlapping degrees between pairs of content display platforms in the at least two content display platforms according to the access users; a screening module configured to determine abnormally accessed content display platforms from the at least two content display platforms according to the access user overlapping degrees and regard them as target content display platforms; and a determination module configured to determine abnormal access users from target access users belonging to the target content display platforms.

In one aspect of the present disclosure, a computer device is provided, including a processor, and a memory. The above processor is connected to the memory, the above memory is configured to store a computer program, and the above processor is configured to call the above computer program to perform the method in the above one aspect of the embodiments of the present disclosure.

In one aspect of the embodiments of the present disclosure, a non-transitory computer-readable storage medium storing a computer program is provided. The computer program includes program instructions, and the program instructions, when executed by a processor, perform the method according to the embodiments of the present disclosure.

In the embodiments of the present disclosure, a computer device may acquire access users associated with at least two content display platforms, and generate access user overlapping degrees between pairs of content display platforms in the at least two content display platforms according to the access users. The access user overlapping degree can reflect identical access users accessing multiple content display platforms. Therefore, abnormally accessed content display platforms may be determined from the at least two content display platforms based on the access user overlapping degree and regarded as target content display platforms. That is, target content display platforms that gather abnormal access users can be identified by the access user overlapping degree. In addition, abnormal access users are determined from access users belonging to the target content display platforms, that is, abnormal access users are identified by analyzing access data and access users of the content display platforms, and thus the accuracy of identifying abnormal access users can be improved. Moreover, it is unnecessary to analyze all access users belonging to at least two content display platforms, which can improve the efficiency of identifying abnormal access users and reduce the complexity of identifying abnormal access users. In addition, abnormal access users in content display platforms can be quickly identified by the access user overlapping degree between the content display platforms, which can avoid the problem of network congestion caused by abnormal access users, and improve the promotion effect of commodities or services. Promotion expenses of products or services of merchants can be reduced, and the accuracy of evaluating the promotion effect can be increased.

### BRIEF DESCRIPTION OF THE DRAWINGS

To describe the technical solutions of the embodiments of the present disclosure or the existing technology more clearly, the following briefly introduces the accompanying drawings required for describing the embodiments or the existing technology. Apparently, the accompanying drawings in the following description show only some embodiments of the present disclosure, and a person of ordinary skill in the art may still derive other accompanying drawings from these accompanying drawings without creative efforts.

FIG. 1 is an architectural diagram of a data processing system according to an embodiment of the present disclosure.

FIG. 2a is an application scenario diagram of a data processing method according to an embodiment of the present disclosure.

FIG. 2b is an application scenario diagram of a data processing method according to an embodiment of the present disclosure.

FIG. 2c is an application scenario diagram of a data processing method according to an embodiment of the present disclosure.

FIG. 3 is a schematic flowchart of a data processing method according to an embodiment of the present disclosure.

FIG. 4a is an application scenario diagram of acquiring a first similarity according to an embodiment of the present disclosure.

FIG. 4b is an application scenario diagram of acquiring a first similarity according to an embodiment of the present disclosure.

FIG. 5a is an application scenario diagram of acquiring a platform network graph according to an embodiment of the present disclosure.

FIG. 5b is a platform network graph according to an embodiment of the present disclosure.

FIG. 5c is a platform network graph according to an embodiment of the present disclosure.

FIG. 6 is a schematic diagram of access amount according to an embodiment of the present disclosure.

FIG. 7 is an application scenario diagram of acquiring a second similarity according to an embodiment of the present disclosure.

FIG. 8 is an application scenario diagram of acquiring a second similarity according to an embodiment of the present disclosure.

FIG. 9 is a schematic diagram of a visualized content display platform according to an embodiment of the present disclosure.

FIG. 10 is a schematic diagram of access amount according to an embodiment of the present disclosure.

FIG. 11 is a schematic structural diagram of a data processing apparatus according to an embodiment of the present disclosure.

FIG. 12 is a schematic structural diagram of a computer device according to an embodiment of the present disclosure.

### DESCRIPTION OF EMBODIMENTS

The technical solutions in embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

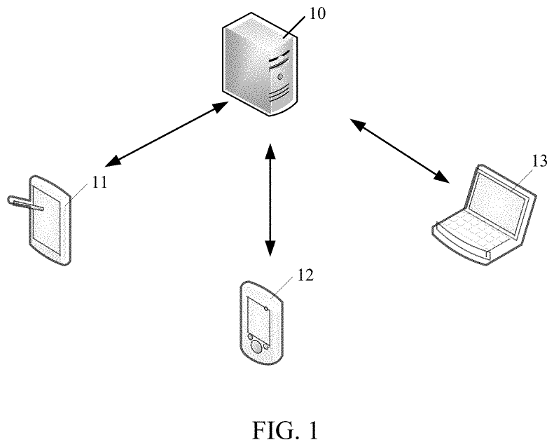

FIG. 1 shows a data processing system according to an embodiment of the present disclosure. The data processing system includes a server 10 and at least one terminal. In FIG. 1, three terminals, namely, a terminal 11, a terminal 12, and a terminal 13 are taken as an example.

The terminal 11, the terminal 12, and the terminal 13 all refer to user-oriented terminals, and the terminal 11, the terminal 12, and the terminal 13 all refer to terminals oriented to users who access a business content (i.e., access users). The terminal 11, the terminal 12, and the terminal 13 may all be smart devices such as smart phones, tablet computers, portable personal computers, smart watches, bracelets, and smart TVs.

The server 10 may refer to a device oriented to a user who publishes the business content (i.e., a publisher). The publisher may refer to a merchant or a traffic owner. The traffic owner may refer to a user or an institution that publishes a business content for a merchant, that is, the traffic owner refers to a user who provides a content display platform for a merchant. The server 10 may be an independent server, a server cluster including several servers, or a cloud computing center. Here, the business content may be referred to as an advertising content, which specifically refers to commodity information or service information that is propagated to consumers or users through an advertising medium in a paid manner in order to promote a commodity or provide a service. The business content may be composed of at least one of a text, a video, an image, a voice, and the like. The content display platform may include a back-end server and a front-end display page. The back-end server is configured to provide services for the front-end display page, such as providing a rendering service for the front-end display page, and responding to an access request of an access user to the front-end display page. The front-end display page of the content display platform may include a service page of an application, such as a session window interface of social software or a web page of an official account; or a web page interface, such as forum space; or, a service page of a mini-program. The official account may refer to an application account, which can realize all-round communication and interaction with a specific group by using texts, pictures, voices, and videos. A mini-program may be an application that can be used without downloading an installation package. The back-end server included in the content display platform may refer to the above server 10, or may refer to an independent server. For example, the server 10 may belong to a common platform. For example, the common platform may be a platform for publishing user generated contents (UGCs) (such as a website or an APP that provides social, blogs, and video content sharing), or a platform for providing third-party services (such as a website or an APP that provides a variety of mini-programs (sub-applications) (of non-native Apps) and web-Apps), and the like. The publishers may be content providers (for example, subscription accounts, such as Facebook Pages) that publish user generated contents on the common platform, service providers that publish mini-programs or web-Apps, and the like. Terminal users are users who consume the user generated contents, mini-programs, or web-Apps on the common platform. The business content is a content related to a commodity or service of a merchant displayed in a reserved position on a page where the user generated content is displayed or a page where the mini-program or web-App is displayed. Each page that displays the user generated content or displays the mini-program or web-App may be regarded as a content display platform.

In one embodiment, when a merchant needs to promote a commodity or service, the server 10 may generate a business content according to commodity information corresponding to the commodity or service information corresponding to the service. The commodity information includes information such as price, name, purchase address, and place of origin of the commodity, and the service information may include information such as price, service content, and service duration. After generating the business content, the server 10 may publish the business content on at least two content display platforms.

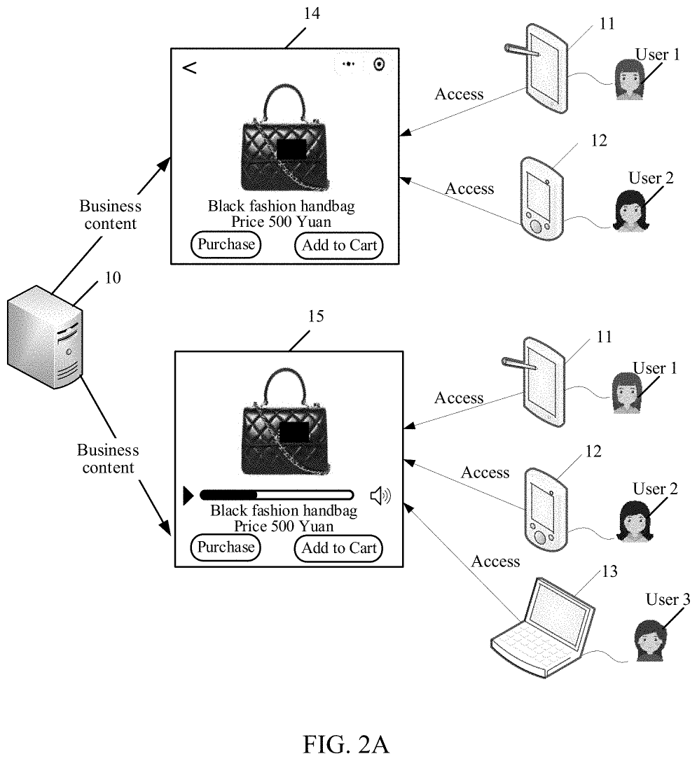

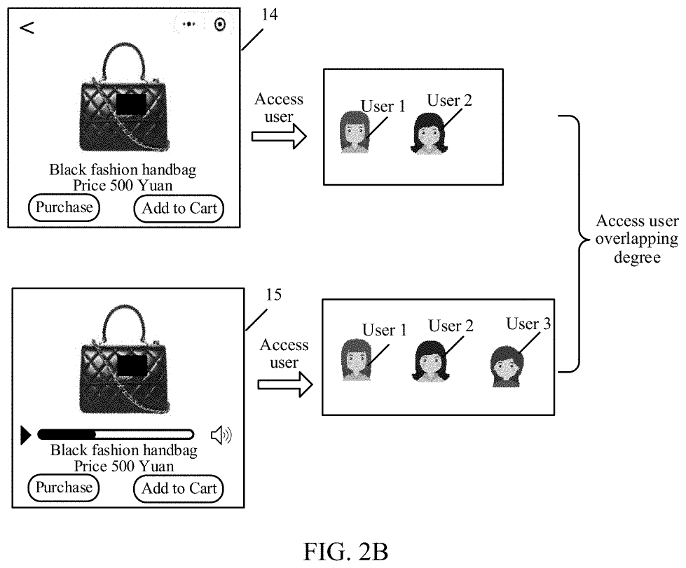

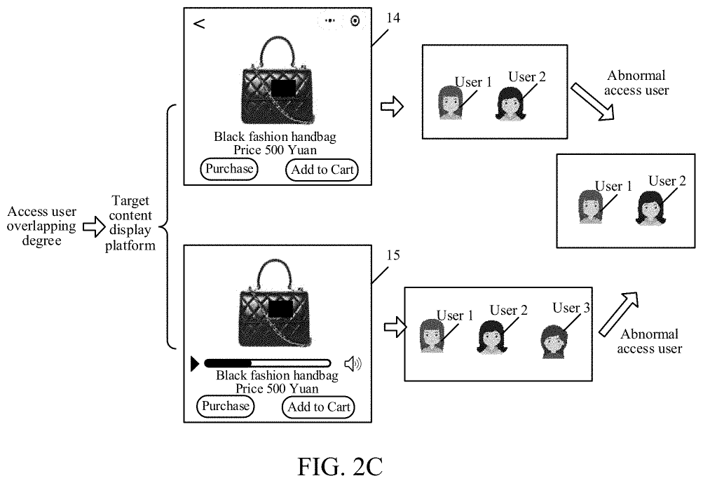

As shown in FIG. 2a, taking promotion of a handbag by a merchant as an example, the content display platforms include a content display platform 1 and a content display platform 2. The content display platform 1 is a mini-program, and the content display platform 2 is a web page. A front-end display interface 14 of the content display platform 1 includes information such as a picture, introduction information (such as the color), and a price of the handbag, and a front-end display interface 15 of the content display platform 2 includes information such as a video, introduction information, and a price of the handbag.

After the server 10 publishes the business content, terminal users corresponding to various terminals may access the business content displayed on the content display platform. Accessing the business content here may include clicking/tapping on the business content, downloading the business content, viewing the business content, and so on.

As shown in FIG. 2b, the server 10 may acquire access behavior data of the users for the business content from the terminals. The access behavior data may include platform identifications of the content display platforms of the business content, user identifications of the access users, access time, the numbers of accesses, and the like.

The server 10 may acquire an access user belonging to the content display platform 1 according to the access behavior data, and acquire an access user belonging to the content display platform 2 according to the access behavior data. The access user belonging to the content display platform 1 refers to a user who has accessed the business content on the content display platform 1, and the access user belonging to the content display platform 2 refers to a user who has accessed the business content on the content display platform 2. The access user belonging to the content display platform 1 and the access user belonging to the content display platform 2 may both include multiple access users. For example, the access users belonging to the content display platform 1 include a user 2 and a user 3, and the access users belonging to the content display platform 2 include a user 1, the user 2, and the user 3.

The server 10 may calculate an access user overlapping degree between the content display platform 1 and the content display platform 2 according to the access users belonging to the content display platform 1 and the access users belonging to the content display platform 2. The access user overlapping degree may be used for reflecting a behavior of the access users in the content display platform 1 and the content display platform 2 accessing multiple content display platforms.

As shown in FIG. 2c, when the access user overlapping degree between the content display platform 1 and the content display platform 2 is less than or equal to a fourth overlapping threshold, it indicates that there are fewer access users in the content display platform 1 and the content display platform 2 who access multiple content display platforms, or there is no access user who accesses multiple content display platforms. Therefore, it can be determined that the content display platform 1 and the content display platform 2 are not accessed abnormally.

When the access user overlapping degree between the content display platform 1 and the content display platform 2 is greater than the fourth overlapping threshold, it indicates that there are a lot of access users in the content display platform 1 and the content display platform 2 who access multiple content display platforms, that is, there are access users who access multiple content display platforms for the purpose of increasing the access amount. Therefore, it can be determined that the content display platform 1 and the content display platform 2 are accessed abnormally, and the content display platform 1 and the content display platform 2 are regarded as target content display platforms.

In some embodiments, the server 10 may regard an identical access user in the content display platform 1 and the content display platform 2 as an abnormal access user. The identical access user in the content display platform 1 and the content display platform 2 refers to an access user who has accessed both the content display platform 1 and the content display platform 2. That is, the identical access user here includes the access user 1 and the access user 2. Therefore, the server 10 may regard the access user 1 and the access user 2 as abnormal access users.

In some embodiments, the server 10 may acquire access behavior data of the access users belonging to the content display platform 1, and determine abnormal access users from the access users belonging to the content display platform 1 according to the access behavior data. Likewise, access behavior data of the access users belonging to the content display platform 2 may be acquired, and abnormal access users may be determined from the access users belonging to the content display platform 2 according to the access behavior data.

As can be seen, abnormal access users in the content display platforms can be quickly identified by the access user overlapping degree between the content display platforms, which can avoid the problem of network congestion caused by abnormal access users, and improve the promotion effect of commodities or services. Promotion expenses of products or services of merchants can be reduced, and the accuracy of evaluating the promotion effect can be increased.

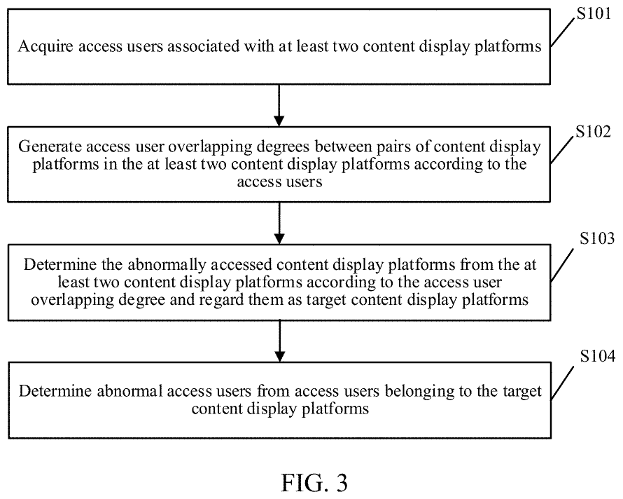

Based on the foregoing description, FIG. 3 is a schematic flowchart of a data processing method according to an embodiment of the present disclosure. The method may be performed by a computer device, and the computer device may refer to the terminal or the server in FIG. 1. As shown in FIG. 3, the method may include the following steps.

Step S101: Acquire access users associated with at least two content display platforms, the at least two content display platforms being configured to provide business contents to the access users.

In order to accurately identify abnormal access user, the computer device may acquire access behavior data about the access users from back-end servers of the at least two content display platforms, or acquire access behavior data about the access users from terminals, or acquire access behavior data about the access users from a third party. The third party may refer to a device managed by a traffic owner or a device used for maintaining data (for example, a user generated content, page data of a mini-program, and the like) provided by a traffic owner. The traffic owner refers to an institution or individual that publishes a business content for a merchant. The access behavior data may include user identifications of the access users associated with the at least two content display platforms, the numbers of accesses, access time, platform identifications of the content display platforms, types of the business contents, and the like. The user identifications may refer to registered user accounts of the access users in the content display platforms or identifications of the devices (such as mobile phone numbers, and serial codes of the mobile phones) used by the access users. The platform identifications may refer to names, version numbers, web page addresses of the content display platforms, or the like. The access users associated with the content display platform may refer to users who access the business content provided by the content display platform. The content display platforms may have identical access users. For example, the user 1 has accessed the business content provided by the content display platform 1 and also accessed the business content provided by the content display platform 2. Therefore, it can be considered that the user 1 belongs to the access users of the content display platform 1 and the content display platform 2. The type of business content may include a business content for promoting an application, a business content for promoting a commodity, and a business content for promoting an article. The applications may include, but are not limited to, game applications, social applications, shopping applications, and the like. The commodities may include clothing, books, food, or the like. The business contents provided by the content display platforms may be the same or different.

Step S102: Generate access user overlapping degrees between pairs of content display platforms in the at least two content display platforms according to the access users.

The computer device may acquire identical access users in the at least two content display platforms, and generate the access user overlapping degree between the at least two content display platforms according to the identical access users. The access user overlapping degree is used for reflecting identical access users accessing multiple content display platforms. It may also be referred to that the access user overlapping degree is used for reflecting the quantity of identical access users in the at least two content display platforms, that is, there is a positive correlation relationship between the quantity of identical access users in the content display platforms and the access user overlapping degree between the content display platforms. That is, a greater quantity of identical access users in the content display platforms indicates a greater access user overlapping degree between the content display platforms. Conversely, a smaller quantity of identical access users in the content display platforms indicates a smaller access user overlapping degree between the content display platforms. Alternatively, the access user overlapping degree is further used for reflecting access behaviors of identical access users in the at least two content display platforms, and the access behaviors may include access durations or the numbers of accesses.

Step S103: Determine abnormally accessed content display platforms from the at least two content display platforms according to the access user overlapping degrees and regard them as target content display platforms.

Abnormal access behaviors to the content display platform include but are not limited to:

\textcircled{1} Accessing, by running scripts, business contents provided by multiple content display platforms;

\hat{2} Inducing, by paying electronic resources to access users, the access users to access the business contents provided by multiple content display platforms;

\hat{3} Faking access behavior data of users to multiple content display platforms; and

\hat{4} Controlling access users by an institution to access multiple content display platforms. That is, a content display platform may control, according to requirements of an institution, access users belonging to the institution to access the content display platform.

In other words, abnormal accesses may refer to behaviors of access users who access multiple content display platforms to artificially increase the access amount (or access traffic) through improper or illegal manners or technical measures, for earning promotion expenses. When an access user overlapping degree between at least two content display platforms is large, it indicates that the quantity of identical access users in the at least two content display platforms is greater, that is, there are identical access users access multiple content display platforms, and then the content display platforms are more likely to be accessed abnormally. That is, when an access user overlapping degree between at least two content display platforms is small, it indicates that the quantity of identical access users in the at least two content display platforms is small, and the probability of the content display platforms accessed abnormally is low. Therefore, the computer device may determine abnormally accessed content display platforms from the at least two content display platforms according to the access user overlapping degrees and regard them as the target content display platforms. The target content display platforms refer to abnormally accessed content display platforms, that is, a large number of abnormal access users are gathered in the target content display platforms. The abnormal access users may refer to users who access the content display platforms for the purpose of improperly increasing the access amount (or access traffic). That is, the target content display platforms may refer to two content display platforms having the largest access user overlapping degree in the at least two content display platforms, or may refer to content display platforms having large access user overlapping degrees with multiple content display platforms.

Step S104: Determine abnormal access users from access users belonging to the target content display platforms.

Merchants usually evaluate promotion effects of products or services based on the access amount of the access users to the business contents, and pay promotion expenses to the content display platforms according to the access amounts of the access users to the business contents. When the access amounts include access amounts generated by abnormal access users, the evaluation accuracy of the promotion effects may be reduced, and the promotion expenses of the products or services by the merchants may be increased. Therefore, after the target content display platforms are determined, the computer device may determine abnormal access users from the access users belonging to the target content display platforms. The access users belonging to the target content display platforms refer to users who have accessed the target content display platforms.

In some embodiments, the computer device may determine, according to the access behavior data of the access users, the abnormal access users from the access users belonging to the target content display platforms. Alternatively, the identical access users in the target content display platforms may be regarded as abnormal access users. By identifying abnormal access users from the access users belonging to the target content display platforms, the promotion expenses of the products or services of the merchants can be reduced, and the accuracy of evaluating the promotion effect can be improved.

In this embodiment of the present disclosure, the computer device may acquire the access users associated with at least two content display platforms, and generate the access user overlapping degree between the at least two content display platforms according to the access users. The access user overlapping degree can reflect identical access users accessing multiple content display platforms, and therefore, abnormally accessed content display platforms may be screened out from the at least two content display platforms based on the access user overlapping degree and regarded as target content display platforms. That is, target content display platforms that gather abnormal access users can be identified by the access user overlapping degree.

In addition, abnormal access users are determined from access users belonging to the target content display platforms, that is, abnormal access users are identified by analyzing access data and access users of the content display platforms, and thus the accuracy of identifying abnormal access users can be improved. Moreover, it is unnecessary to analyze all access users belonging to at least two content display platforms, which can improve the efficiency of identifying abnormal access users and reduce the complexity of identifying abnormal access users.

In addition, abnormal access users in content display platforms can be quickly identified by the access user overlapping degree between the content display platforms, which can avoid the problem of network congestion caused by abnormal access users, and improve the promotion effect of commodities or services. Promotion expenses of products or services of merchants can be reduced, and the accuracy of evaluating the promotion effect can be increased.

In an embodiment, the at least two content display platforms include a content display platform Kᵢ and a content display platform Kⱼ, both i and j are positive integers less than or equal to N, and N is the quantity of content display platforms of the at least two content display platforms. Step S102 may include the following steps s11 to s13.

Step s11: Regard access users belonging to the content display platform Kᵢ as a first access user set, and regard access users belonging to the content display platform Kⱼ as a second access user set.

Step s12: Acquire a similarity between the first access user set and the second access user set and regard it as a first similarity.

Step s13: Determine an access user overlapping degree between the content display platform Kᵢ and the content display platform Kⱼ according to the first similarity.

In steps s11 to s13, the computer device may determine the access users belonging to the content display platform Kᵢ and regard them as the first access user set, and determine the access users belonging to the content display platform Kⱼ and regard them as the second access user set.

In some embodiments, the method of acquiring the first access user set and the second access user set may include a direction acquisition method or an extended acquisition method.

The direct acquisition method refers to: regarding access users who access the content display platform Kᵢ as the first access user set; and regarding access users who access the content display platform Kⱼ as the second access user set.

The extended acquisition method refers to: determining the first access user set according to the access users belonging to the content display platform Kᵢ and corresponding access behavior data, and determining the second access user set according to the access users belonging to the content display platform Kⱼ and corresponding access behavior data. In the extended acquisition method, the first access user set and the second access user set are acquired by considering the access behavior data of the access users, thus being conducive to accurately identifying abnormal content display platforms.

The content display platform Kᵢ may refer to any content display platform in the at least two content display platforms, and the content display platform Kⱼ may be the other content display platform in the at least two content display platforms except the content display platform Kᵢ.

After acquiring the first access user set and the second access user set, the computer device may acquire a similarity between the first access user set and the first access user set and regard it as a first similarity. The first similarity may be used for reflecting the quantity of identical access users in the first access user set and the second access user set, that is, a larger quantity of identical access users indicates a larger first similarity. A smaller quantity of identical access users indicates a smaller first similarity.

After acquiring the first similarity, the computer device may determine an access user overlapping degree between the content display platform Kᵢ and the content display platform Kⱼ according to the first similarity. The first similarity has a positive correlation relationship with the access user overlapping degree between the content display platform Kᵢ and the content display platform Kⱼ, that is, a larger first similarity indicates a larger access user overlapping degree between the content display platform Kᵢ and the content display platform Kⱼ. A smaller first similarity indicates a smaller access user overlapping degree between the content display platform Kᵢ and the content display platform Kⱼ.

In some embodiments, the computer device may regard the first similarity as the access user overlapping degree between the content display platform Kᵢ and the content display platform Kⱼ.

In this embodiment, step s11 may include the following steps s21 to s26.

Step s21: Regard access users belonging to the content display platform Kᵢ as a first candidate access user set.

Step s22: Regard access users belonging to the content display platform Kⱼ as a second candidate access user set.

Step s23: Acquire the number of accesses to the content display platform Kᵢ by the access users belonging to the content display platform Kᵢ and regard it as a first number of accesses, and acquire the number of accesses to the content display platform Kⱼ by the access users belonging to the content display platform Kⱼ and regard it as a second number of accesses.

Step s24: Generate virtual access users corresponding to the access users belonging to the content display platform Kᵢ according to the first number of accesses and regard them as first virtual access users, the quantity of the first virtual access users having a positive correlation relationship with the first number of accesses.

Step s25: Generate virtual access users corresponding to the access users belonging to the content display platform Kⱼ according to the second number of accesses and regard them as second virtual access users, the quantity of the second virtual access users having a positive correlation relationship with the second number of accesses.

Step s26: Add the first virtual access users to the first candidate access user set to obtain the first access user set, and add the second virtual access users to the second candidate access user set to obtain the second access user set.

In steps s21 to s26, the abnormal access users have accessed multiple content display platforms, or accessed the same content display platform multiple times, and therefore, in order to improve the accuracy of identifying the abnormally accessed content display platforms, the computer device may acquire access user sets according to the numbers of accesses of the access users.

In some embodiments, the computer device may regard the access users belonging to the content display platform Kᵢ as the first candidate access user set, and regard the access users belonging to the content display platform Kⱼ as the second candidate access user set. Then, the number of accesses to the content display platform Kᵢ by the access users belonging to the content display platform Kᵢ may be acquired from the access behavior data and regarded as the first number of accesses, and the number of accesses to the content display platform Kⱼ by the access users belonging to the content display platform Kⱼ may be acquired from the access behavior data and regarded as the second number of accesses. The first number of accesses may refer to the numbers of accesses to the content display platform Kᵢ respectively by various access users belonging to the content display platform Kᵢ in a time period, and the second number of accesses may refer to the numbers of accesses to the content display platform Kⱼ respectively by various access users belonging to the content display platform Kⱼ in a time period. The time period may refer to within the past week or within the past month, and so on.

After acquiring the first number of accesses and the second number of accesses, the computer device may generate virtual access users corresponding to the access users belonging to the content display platform Kᵢ according to the first number of accesses and regard them as first virtual access users, the quantity of the first virtual access users having a positive correlation relationship with the first number of accesses. That is, a larger first number of accesses indicates a larger quantity of the generated first virtual access users corresponding to the access users belonging to the content display platform Kᵢ. A smaller first number of accesses indicates a smaller quantity of the generated first virtual access users corresponding to the access users belonging to the content display platform Kᵢ. User identifications of the first virtual access users are different from user identifications of the access users belonging to the content display platform Kᵢ. Likewise, virtual access users corresponding to the access users belonging to the content display platform Kⱼ may be generated according to the second number of accesses and regarded as second virtual access users, the quantity of the second virtual access users having a positive correlation relationship with the second number of accesses. That is, a larger second number of accesses indicates a larger quantity of the generated second virtual access users corresponding to the access users belonging to the content display platform Kⱼ. A smaller second number of accesses indicates a smaller quantity of the generated second virtual access users corresponding to the access users belonging to the content display platform Kⱼ. User identifications of the second virtual access users are different from user identifications of the access users belonging to the content display platform Kⱼ. After the first virtual access users and the second virtual access users are acquired, the first virtual access users may be added to the first candidate access user set to obtain the first access user set, and the second virtual access users may be added to the second candidate access user set to obtain the second access user set.

In some embodiments, the computer device may acquire the access user sets according to access durations and the access users, and the computer device may regard the access users belonging to the content display platform Kᵢ as the first candidate access user set, and regard the access users belonging to the content display platform Kⱼ as the second candidate access user set. Then, an access duration to the content display platform Kᵢ by the access users belonging to the content display platform Kᵢ may be acquired from the access behavior data and regarded as a first access duration, and an access duration to the content display platform Kⱼ by the access users belonging to the content display platform Kⱼ may be acquired from the access behavior data and regarded as a second access duration. The first access duration may refer to a cumulative access duration of accesses to the content display platform Kᵢ by the various access users belonging to the content display platform Kᵢ, and the second access duration may refer to a cumulative access duration of accesses to the content display platform Kⱼ by the various access user belonging to the content display platform Kⱼ in a time period. The time period may refer to within the past week or within the past month, and so on.

After acquiring the first access duration and the second access duration, the computer device may generate virtual access users corresponding to the access users belonging to the content display platform Kᵢ according to the first access duration and regard them as first virtual access users, the quantity of the first virtual access users having a positive correlation relationship with the first access duration. That is, a larger first access duration indicates a larger quantity of the generated first virtual access users corresponding to the access users belonging to the content display platform Kᵢ. A smaller first access duration indicates a smaller quantity of the generated first virtual access users corresponding to the access users belonging to the content display platform Kᵢ. User identifications of the first virtual access users are different from user identifications of the access users belonging to the content display platform Kᵢ. Likewise, virtual access users corresponding to the access users belonging to the content display platform Kⱼ may be generated according to the second access duration and regarded as second virtual access users, the quantity of the second virtual access users having a positive correlation relationship with the second access duration. That is, a larger second access duration indicates a larger quantity of the generated second virtual access users corresponding to the access users belonging to the content display platform Kⱼ. A smaller second access duration indicates a smaller quantity of the generated second virtual access users corresponding to the access users belonging to the content display platform Kⱼ. User identifications of the second virtual access users are different from user identifications of the access users belonging to the content display platform Kⱼ. After the first virtual access users and the second virtual access users are acquired, the first virtual access users may be added to the first candidate access user set to obtain the first access user set, and the second virtual access users may be added to the second candidate access user set to obtain the second access user set.

In this embodiment, step s12 may include the following steps s31 to s33.

Step s31: Acquire access users having identical user identifications in the first access user set and the second access user set and regard them as an overlapping access user set.

Step s32: Merge the first access user set and the second access user set to obtain a merged access user set.

Step s33: Regard a ratio of the overlapping access user set to the merged access user set as the first similarity.

In steps s31 to s33, the computer device may acquire the access users having identical user identifications in the first access user set and the second access user set and regard them as the overlapping access user set, that is, access users having identical user identifications may refer to identical access users in the first access user set and the second access user set.

In some embodiments, an intersection of the first access user set and the second access user set may be acquired to obtain the overlapping access user set. Then, the first access user set and the second access user set may be merged to obtain the merged access user set, that is, a union of the first access user set and the second access user set is acquired to obtain the merged access user set. After acquiring the overlapping access user set and the merged access user set, the computer device may regard the ratio of the overlapping access user set to the merged access user set as the first similarity. The access user overlapping degree between the content display platform Kᵢ and the content display platform Kⱼ is calculated by the first access user set and the second access user set, and there is no need to separately traverse access users of the content display platform Kᵢ and the content display platform Kⱼ, thus reducing the complexity of calculating the access user overlapping degree of between the content display platform Kᵢ and the content display platform Kⱼ, and shortening a duration for calculating the access user overlapping degree.

In some embodiments, the first similarity may be expressed by the following formula (1).

$$F 1 = \frac{P ⋂ Q}{p ⋃ Q} \qquad ( 1 )$$

In the formula (1), P and Q respectively represent the first access user set and the second access user set, P∩Q represents the intersection of the first access user set and the second access user set, and P∪Q represents the union of the first access user set and the second access user set, and F1 represents the first similarity.

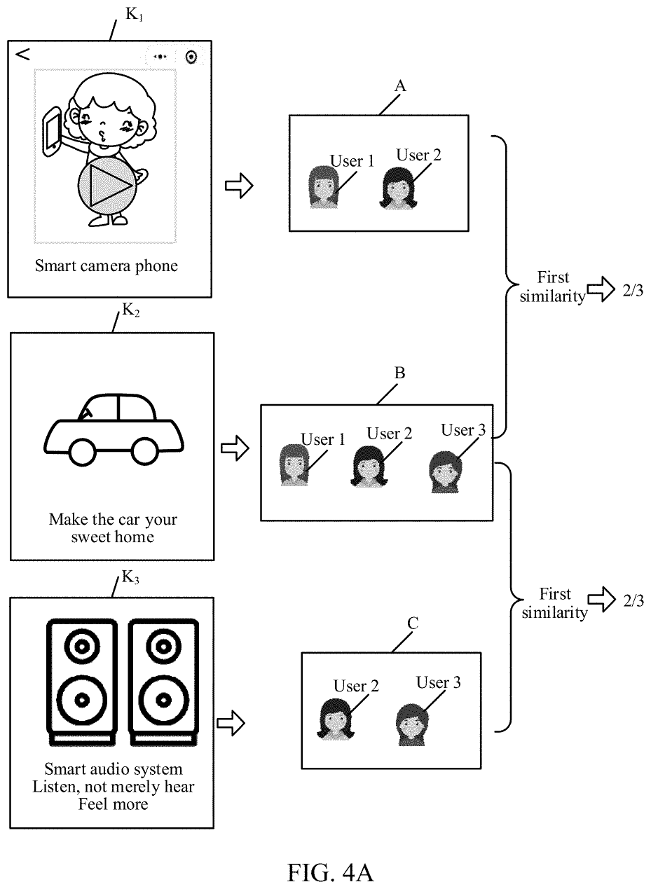

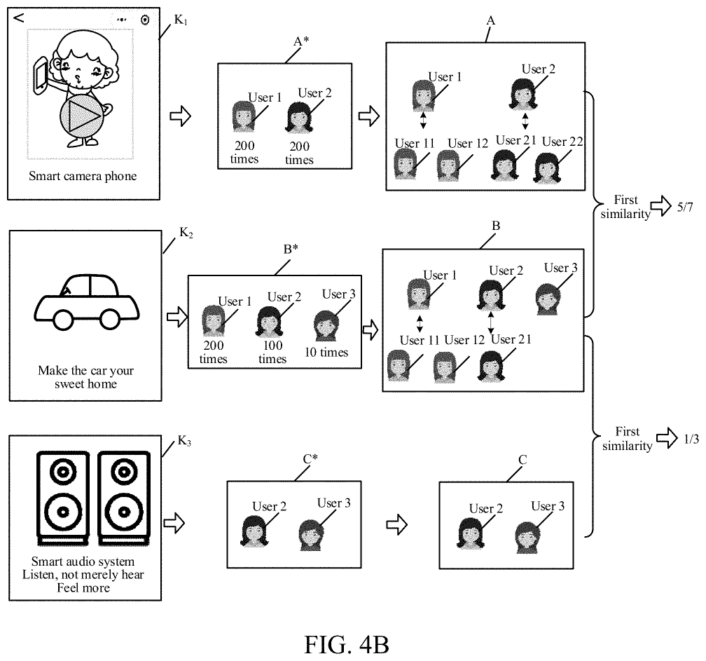

For example, it is assumed that the at least two content display platforms include a content display platform K₁, a content display platform K₂, and a content display platform K₃. As shown in Table 1, access users belonging to the content display platform K₁ include a user 1 and a user 2, access users belonging to the content display platform K₂ include the user 1, the user 2, and a user 3, and access users belonging to the content display platform K₃ include the user 2 and the user 3. It is assumed that access user sets corresponding to the content display platform K₁, the content display platform K₂, and the content display platform K₃ are A, B, and C, respectively, and candidate access user sets corresponding to the content display platform K₁, the content display platform K₂, and the content display platform K₃ are A*, B*, and C*, respectively. It is assumed that the content display platforms K₁, K₂, and K₃ provide different business contents, the content display platform K₁ provides a business content about recommending a smart phone, the content display platform K₂ provides a business content about recommending a car, and the content display platform K₃ provides a business content about recommending a smart speaker. As shown in FIG. 4a, when the access user sets are acquired by the direct acquisition method, the access user set A of the content display platform K₁ is (user 1, user 2), and the access user set B of the content display platform K₂ is (user 1, user 2, user 3), and the access user set C of the content display platform K₃ is (user 2, user 3). A∪B is (user 1, user 2, user 3), A∩B is (user 1, user 2), and the first similarity between A and B is 2/3 calculated by using the formula (1). Similarly, C∪B is (user 1, user 2, user 3), C∩B is (user 2, user 3), and the first similarity between C and B is 2/3 calculated by using the formula (1).

TABLE 1

| | |
|---|---|
| Content display platform | The number of accesses of the user 1 is 200 |
| K₁ | The number of accesses of the user 2 is 200 |
| Content display platform | The number of accesses of the user 1 is 200 |
| K₂ | The number of accesses of the user 2 is 100 |
| | The number of accesses of the user 3 is 10 |
| Content display platform | The number of accesses of the user 2 is 10 |
| K₃ | The number of accesses of the user 3 is 10 |

As shown in FIG. 4b, when the access user sets are acquired by the extended acquisition method, the access users belonging to the content display platform K₁ may be regarded as the candidate access user set A*, and the candidate access user set A* is (user 1, user 2); the access users belonging to the content display platform K₂ may be regarded as the candidate access user set B*, and the candidate access user set B* is (user 1, user 2, user 3); and the access users belonging to the content display platform K₃ may be regarded as the candidate access user set C*, and the candidate access user set C* is (user 2, user 3).

As shown in Table 1, the numbers of accesses of the user 1 and the user 2 to the content display platform K₁ are 200 and 100, respectively. The second numbers of accesses of the user 1, the user 2, and the user 3 to the content display platform K₂ are 200, 100, and 10, respectively. The second numbers of accesses of the user 2 and the user 3 to the content display platform K₃ are 10 and 10, respectively.

The computer device may generate first virtual access users corresponding to the user 1 according to the number of accesses of the user 1 to the content display platform K₁, including a user 11 and a user 12, and generate first virtual access users corresponding to the user 2 according to the number of accesses of the user 2 to the content display platform K₁, including a user 21 and a user 22. Likewise, the computer device may generate second virtual access users corresponding to the user 1 according to the number of accesses of the user 1 to the content display platform K₂, including the user 11 and the user 12, and generate a second virtual access user corresponding to the user 2 according to the number of accesses of the user 2 to the content display platform K₂, including the user 21. The number of accesses of the user 3 to the content display platform K₂ is small, and therefore, no second virtual access user of the user 3 is generated. Meanwhile, the numbers of accesses of the user 2 and the user 3 to the content display platform K₃ are relatively small, and therefore, virtual access users corresponding to the access users belonging to the content display platform K₃ may not be generated. That is, the candidate access user set C* may be regarded as the access user set C, and C is (user 2, user 3).

After acquiring the first virtual access users and the second virtual access users, the computer device may add the first virtual access users to the candidate access user set A* to obtain the access user set A, that is, the access user set A is (user 1, user 11, user 12, user 2, user 21, user 22); and add the second virtual access users to the candidate access user set B* to obtain the access user set B, that is, the access user set B is (user 1, user 11, user 12, user 2, user 21, user 3). User identifications respectively corresponding to the user 1, the user 11, and the user 12 are different, and user identifications respectively corresponding to the user 2 and the user 21 are also different. At this time, A∪B is (user 1, user 11, user 12, user 2, user 21, user 22, user 3), A∩B is (user 1, user 11, user 12, user 2, user 21), and the first similarity is 5/7 calculated by using the formula (1). Similarly, C∪B is (user 1, user 11, user 12, user 2, user 21, user 3), C∩B is (user 2, user 3), and the first similarity between C and B is 1/3 calculated by using the formula (1).

As can be seen from Table 1, in the content display platform K₁ and the content display platform K₂, there are access users who access the same content display platform multiple times, and there are access users who access different content display platforms multiple times. In other words, the probability of the content display platform K₁ and the content display platform K₂ being abnormal content display platforms is larger, that is, theoretically, the similarity between the content display platform K₁ and the content display platform K₂ is larger. As can be seen by comparing the direct acquisition method and the extended acquisition method of the above access user sets, the use of the extended acquisition method expands the similarity between the content display platforms with large numbers of accesses, which is more conducive to accurately identifying abnormally accessed content display platforms.

In an embodiment, step S103 may include the following steps s41 to s42.

Step s41: Determine the at least two content display platforms as at least two nodes, and connect two nodes, in the at least two nodes, whose access user overlapping degree is greater than a first overlapping threshold to obtain a platform network graph including the at least two nodes.

Step s42: When a complete subgraph is included in the platform network graph, and the quantity of nodes in the complete subgraph is greater than a first quantity threshold, regard two nodes, in the complete subgraph, whose access user overlapping degree is greater than a second overlapping threshold as the target content display platforms.

In steps s41 to s42, the computer device may determine the at least two content display platforms as at least two nodes, and connect two nodes, in the at least two nodes, whose access user overlapping degree is greater than the first overlapping degree to obtain the platform network graph including the at least two nodes. By connecting two nodes with an access user overlapping degree greater than the first overlapping degree, it is possible to avoid connecting nodes with an access user overlapping degree being zero, and to avoid connecting nodes with a small access user overlapping degree, which can improve the accuracy of acquiring abnormal content display platforms.

The access user overlapping degree between nodes being zero may refer to that the corresponding content display platforms do not have any identical access users, and the small access user overlapping degree between nodes may refer to that the corresponding content display platforms have a small quantity of identical access users, or the access user overlapping degree between the nodes is small due to a calculation error.

The platform network graph may be used for indicating the access user overlapping degree between the content display platforms. That is, the platform network graph includes multiple nodes and multiple edges, each node corresponds to a content display platform, and a weight of each edge is an access user overlapping degree between content display platforms.

After acquiring the platform network graph, the computer device judges whether a complete subgraph is included in the platform network graph. The complete subgraph refers to a graph composed of three nodes or more than three nodes connected to each other in the platform network graph. When the complete subgraph is not included in the platform network graph, this process may be ended. When a complete subgraph is included in the platform network graph, the quantity of nodes in the complete subgraph may be acquired. When the quantity of nodes in the complete subgraph is greater than the first quantity threshold, it indicates that there are identical access users in every two content display platforms, and there is a large access user overlapping degree between every two nodes. Two nodes with an access user overlapping degree greater than a second overlapping threshold in the complete subgraph are regarded as the target content display platforms. The target content display platforms have access users who access multiple content display platforms, that is, the target content display platforms are abnormally accessed content display platforms.

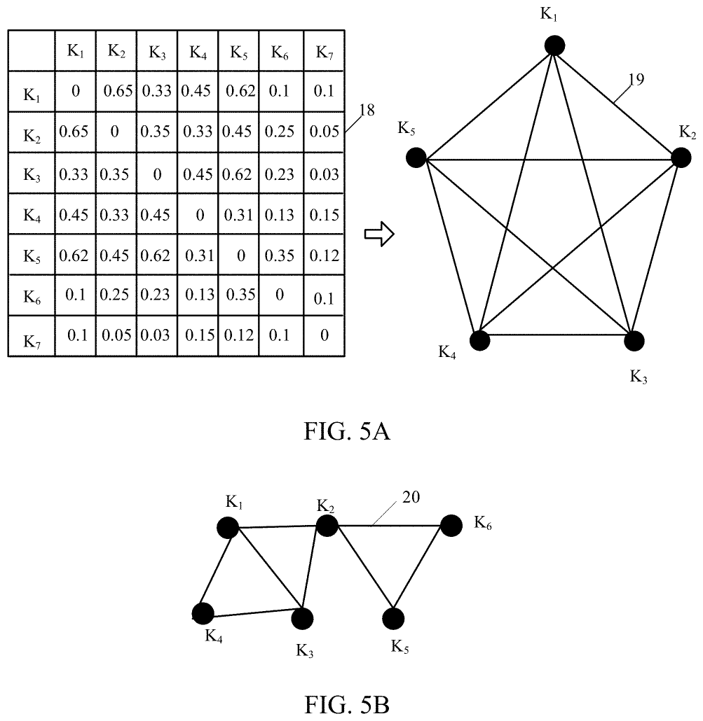

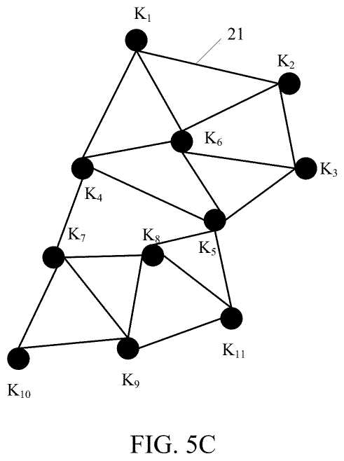

For example, as shown in FIG. 5a, the above at least two content display platforms include content display platforms K₁, K₂, K₃, K₄, K₅, K₆, and K₇. Access user overlapping degrees between the content display platforms are shown in Table 18. The access user overlapping degrees of K₁ with K₂, K₃, K₄, K₅, K₆, and K₇ are 0.65, 0.33, 0.45, 0.62, 0.1, and 0.1, respectively. The access user overlapping degrees of K₂ with K₃, K₄, K₅, K₆, and K₇ are 0.35, 0.33, 0.45, 0.25, and 0.05, respectively. The access user overlapping degrees of K₃ with K₄, K₅, K₆, and K₇ are 0.45, 0.62, 0.23, and 0.03, respectively. The access user overlapping degrees of K₄ with K₅, K₆, and K₇ are 0.31, 0.13, and 0.15, respectively. The access user overlapping degrees of K₅ with K₆ and K₇ are 0.35 and 0.12, respectively. The access user overlapping degree of K₆ with K₇ is 0.1.

It is assumed that the first overlapping degree threshold and the second overlapping degree threshold are 0.3 and 0.63, respectively, and the first quantity threshold is 3. The computer device may regard K₁, K₂, K₃, K₄, K₅, K₆, and K₇ as at least two nodes. The access user overlapping degrees between K₁, K₂, K₃, K₄, and K₅ are all greater than 0.3, and therefore, K₁, K₂, K₃, K₄, and K₅ are connected to obtain a platform network graph (the platform network graph is marked as 19 in FIG. 5a). Every two nodes in the platform network graph are connected, and it can be determined that the platform network graph is a complete graph, that is, the platform network graph is a complete subgraph. The access user overlapping degree of K₁ and K₂ in the complete subgraph is greater than 0.63, and therefore, K₁ and K₂ may be accessed abnormally, and K₁ and K₂ may be regarded as the target content display platforms.

In some embodiments, the complete subgraph included in the platform network graph may refer to that a graph formed by connecting some nodes in the platform network graph is a complete graph. As shown in FIG. 5b, a platform network graph (the platform network graph is marked as 20 in FIG. 5b) includes content display platforms K₁, K₂, K₃, K₄, K₅, and K₆. In the platform network graph, K₁, K₂, and K₃ are connected to each other, that is, a graph formed by connecting K₁, K₂, and K₃ to each other is a complete subgraph. K₂, K₅, and K₆ are connected to each other, that is, a graph formed by connecting K₂, K₅, and K₆ to each other is a complete subgraph. K₁, K₃, and K₄ are connected to each other, that is, a graph formed by connecting K₁, K₃, and K₄ to each other is a complete subgraph. Therefore, it can be determined that a complete subgraph is included in the platform network graph in FIG. 5b. Likewise, as shown in FIG. 5c, a platform network graph (the platform network graph is marked as 21 in FIG. 5c) includes content display platforms K₁, K₂, K₃, K₄, K₅, K₆, K₇, K₈, K₉, K₁₀, and K₁₁. In the platform network graph, (K₁, K₂, K₄); (K₂, K₃, K₆), (K₃, K₅, K₆); (K₄, K₅, K₆); (K₅, K₈, K₁₀); (K₇, K₈, K₉); (K₇, K₉, K₁₀); (K₈, K₉, K₁₁) are node groups with nodes connected to each other, that is, each graph formed by connecting nodes in aforementioned node groups to each other is a complete subgraph. Therefore, it can be determined that a complete subgraph is included in the platform network graph in FIG. 5c. In some embodiments, a complete subgraph included in the platform network graph may refer to that the graph formed by connecting nodes in the platform network graph is a complete graph, that is, the platform network graph is a complete subgraph, as shown in FIG. 5a. In other words, various content display platforms in the platform network graph are connected to each other, that is, the platform network graph in FIG. 5a is a complete subgraph.

In an embodiment, step S103 may include the following steps s51 to s53.

Step s51: Determine, from the at least two content display platforms, a content display platform whose access user overlapping degree with a first content display platform is greater than a third overlapping threshold as a second content display platform, the first content display platform belonging to the at least two content display platforms.

Step s52: Acquire the quantity of the second content display platforms.

Step s53: When the quantity of the second content display platforms is greater than a second quantity threshold, regard the first content display platform as the target content display platform.

In steps s51 to s53, the computer device may determine, from the at least two content display platforms, a content display platform whose access user overlapping degree with a first content display platform is greater than the third overlapping threshold and regard it as the second content display platform, and acquire the quantity of the second content display platforms. When the quantity of the second content display platforms is less than or equal to the second quantity threshold, it indicates that there is no access user in the first content display platform who accesses multiple content display platforms, or it indicates that there are fewer access users in the first content display platform who access multiple content display platforms, and the first content display platform is not regarded as the target content display platform. When the quantity of the second content display platforms is greater than the second quantity threshold, it indicates that there are a lot of access users in the first content display platform who access multiple content display platforms, and the first content display platform is regarded as the target content display platform.

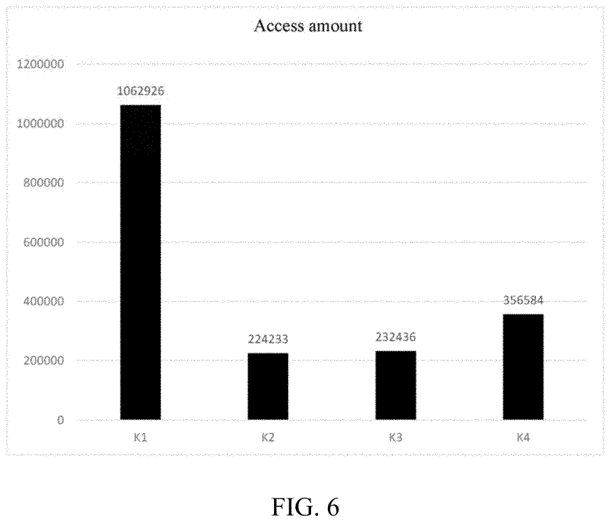

In some embodiments, the computer device may acquire the number of accesses (i.e., the access amount) to the content display platform, and determine, according to the access amount, the abnormally accessed content display platform. It is assumed that the above at least two content display platforms include the content display platforms K₁, K₂, K₃, and K₄, as shown in FIG. 6. FIG. 6 shows average daily access amounts of the content display platforms K₁, K₂, K₃, and K₄, respectively. The average daily access amounts of the content display platforms K₁, K₂, K₃, and K₄ are 1062926 times, 224233 times, 232436 times, and 356584 times, respectively. As can be seen, the average daily access amounts of the content display platforms K₁, K₂, K₃, and K₄ are all more than 100,000 times. Therefore, it can be determined that the content display platforms K₁, K₂, K₃, and K₄ are abnormally accessed content display platforms.

In an embodiment, step S104 may include the following steps s61 to s62.

Step s61: Acquire access behavior data of access users belonging to the target content display platforms.

Step s62: Determine abnormal access users from the access users belonging to the target content display platforms according to the access behavior data.

In steps s61 to s62, the computer device may acquire access behavior data of the access users belonging to the target content display platforms from back-end servers of the target content display platforms or from terminals that display the target content display platforms. The access behavior data includes one or more of the accessed content display platforms, the numbers of accesses, the access durations, and institutions to which the access users belong. The institutions to which the access users belong may be institutions that pay electronic resources to the access users, that is, institutions where the access users are operated. After acquiring the access behavior data, the computer device may determine abnormal access users from the access users belonging to the target content display platforms according to the access behavior data. The abnormal access users may refer to users who access the content display platform for the purpose of obtaining access amount, that is, users who have cheating behaviors. For example, abnormal access users may refer to access users belonging to the target content display platforms who access multiple content display platforms, or may refer to access users whose access durations are greater than a duration threshold, or the like. An abnormal access user may be a user that helps a content providers make extra advertising revenue by excessively increasing the number of exposures and clicks of an advertisement shown by the content provider. For example, a normal access user would just click the advertisement for one or two (or other reasonable number of) times, but the abnormal user clicks the same advertisement for excessive number of times, such as 50. Further, the content provider may pay the abnormal access user for creating the excessive clicks/exposures. In another example, the cheating behaviors may include creating fake access records of users clicking ads for real game users through operators or routers while the real game users did not actually see the ads.

In this embodiment, an access user Pₘ and an access user Pₙ belong to the target content display platforms, m and n are both positive integers less than or equal to T, T is the quantity of access users belonging to the target content display platforms, and the access behavior data includes the accessed content display platforms. Step s62 may include the following steps s71 to s73.

Step s71: Regard content display platforms accessed by the access user Pₘ as a first content display platform set, and regard content display platforms accessed by the access user Pₙ as a second content display platform set.

Step s72: Acquire a similarity between the first content display platform set and the second content display platform set and regard it as a second similarity.

Step s73: When the second similarity degree is greater than a similarity threshold, regard the access user Pₘ and the access user Pₙ as abnormal access users.

In steps s71 to s73, the computer device may determine the content display platforms accessed by the access user Pₘ from the access behavior data and regard them as the first content display platform set, and determine the content display platforms accessed by the access user Pₙ from the access behavior data and regard them as the second content display platform set.

In some embodiments, the method of acquiring the content display platform set includes a direction acquisition method or an extended acquisition method.

The direct acquisition method refers to regarding the content display platforms accessed by the access user Pₘ as the first content display platform set, and regarding the content display platforms accessed by the access user Pₙ as the second content display platform set.

The extended acquisition method refers to determining the first content display platform set according to the content display platforms accessed by the access user Pₘ and the corresponding number of accesses or access duration; and determining the second content display platform set according to the content display platforms accessed by the access user Pₙ and the corresponding number of accesses or access duration. In the extended acquisition method, the second content display platform set and the first content display platform set are acquired by considering the access behavior data (i.e., the number of accesses or access duration) of the access users, thus being conducive to accurately identifying abnormal access users.

After acquiring the second content display platform set and the first content display platform set, the computer device may acquire the similarity between the first content display platform set and the second content display platform set and regard it as the second similarity. The second similarity may be used for reflecting the quantity of content display platforms accessed by both the access user Pₘ and the access user Pₙ. That is, a greater quantity of content display platforms accessed by both access users indicates a greater second similarity. A smaller quantity of content display platforms accessed by both access users indicates a smaller second similarity. When the second similarity is less than or equal to a similarity threshold, the quantity of content display platforms accessed by both the access user Pₘ and the access user Pₙ is small, and it is determined that the access user Pₘ and the access user Pₙ are not abnormal access users. When the second similarity is greater than the similarity threshold, the quantity of content display platforms accessed by both the access user Pₘ and the access user Pₙ is large, that is, there is an abnormal situation that the access user Pₘ and the access user Pₙ access multiple content display platforms, and therefore, the access user Pₘ and the access user Pₙ are regarded as abnormal access users. Abnormal access users can be identified quickly by the similarity between the first content display platform set and the second content display platform set, promotion expenses of products or services of merchants can be reduced, and the accuracy of evaluating the promotion effect can be improved.

Step s71 may include the following steps s81 to s85.

Step s81: Regard content display platforms accessed by the access user Pₘ as a first candidate content display platform set, and regard content display platforms accessed by the access user Pₙ as a second candidate content display platform set.

Step s82: Acquire the number of accesses by the access user Pₘ to the content display platforms in the first candidate content display platform set and regard it as a third number of accesses; and acquire the number of accesses by the access user Pₙ to the content display platforms in the second candidate content display platform set and regard it as a fourth number of accesses.

Step s83: Generate virtual content display platforms corresponding to the content display platforms in the first candidate content display platform set according to the third number of accesses and regard them as first virtual content display platforms, the quantity of the first virtual content display platforms having a positive correlation relationship with the third number of accesses.

Step s84: Generate virtual content display platforms corresponding to the content display platforms in the second candidate content display platform set according to the fourth number of accesses and regard them as second virtual content display platforms, the quantity of the second virtual content display platforms having a positive correlation relationship with the fourth number of accesses.

Step s85: Add the first virtual content display platforms to the first candidate content display platform set to obtain the first content display platform set; and add the second virtual content display platforms to the second candidate content display platform set to obtain the second content display platform set.

In steps s81 to s85, the abnormal access users have accessed multiple content display platforms, or accessed the same content display platform multiple times, and therefore, in order to improve the accuracy of identifying the abnormal access users, the computer device may acquire the content display platform sets according to the numbers of accesses of the access users.

In some embodiments, the computer device may regard the content display platforms accessed by the access user Pₘ as the first candidate content display platform set, and regard the content display platforms accessed by the access user Pₙ as the second candidate content display platform set. Then, the number of accesses of the access user Pₘ to the content display platforms in the first candidate content display platform set may be acquired from the access behavior data and regarded as a third number of accesses; and the number of accesses of the access user Pₙ to the content display platforms in the second candidate content display platform set may be acquired from the access behavior data and regarded as a fourth number of accesses. The third number of accesses is the number of accesses to the content display platforms in the first candidate content display platform set in a time period by the access user Pₘ, and the fourth number of accesses is the number of accesses to the content display platforms in the second candidate content display platform set in a time period by the access user Pₙ.

After acquiring the third number of accesses and the fourth number of accesses, the computer device may generate, according to the third number of accesses, the virtual content display platforms corresponding to the content display platforms in the first candidate content display platform set and regard them as first virtual content display platforms, the quantity of the first virtual content display platforms having a positive correlation relationship with the third number of accesses. That is, a greater third number of accesses indicates more generated first virtual content display platforms. Conversely, a smaller third number of accesses indicates fewer generated first virtual content display platforms. Likewise, the virtual content display platforms corresponding to the content display platforms in the second candidate content display platform set may be generated according to the fourth number of accesses and regarded as second virtual content display platforms, the quantity of the second virtual content display platforms having a positive correlation relationship with the fourth number of accesses. That is, a greater fourth number of accesses indicates more generated second virtual content display platforms. Conversely, a smaller fourth number of accesses indicates fewer generated second virtual content display platforms.

After acquiring the first virtual content display platforms and the second virtual content display platforms, the computer device adds the first virtual content display platforms to the first candidate content display platform set to obtain the first content display platform set; and adds the second virtual content display platforms to the second candidate content display platform set to obtain the second content display platform set.

In this embodiment, step s72 may include the following steps s91 to s93.

Step s91: Acquire content display platforms having identical platform identifications in the first content display platform set and the second content display platform set and regard them as an overlapping content display platform set.

Step s92: Merge the first content display platform set and the second content display platform set to obtain a merged content display platform set.

Step s93: Regard a ratio of the overlapping content display platform set to the merged content display platform set as the second similarity.

In steps s91 to s93, the computer device may acquire the content display platforms having identical platform identifications in the first content display platform set and the second content display platform set and regard them as the overlapping content display platform set, that is, the content display platforms having identical platform identifications are identical content display platforms in the first content display platform set and the second content display platform set.

In some embodiments, an intersection of the first content display platform set and the second content display platform set may be acquired to obtain the overlapping content display platform set. Then, the first content display platform set and the second content display platform set are merged to obtain the merged content display platform set, that is, a union of the first content display platform set and the second content display platform set is acquired to obtain the merged content display platform set. The computer device may regard the ratio of the overlapping content display platform set to the merged content display platform set as the second similarity. By calculating the similarity between the access user Pₘ and the access user Pₙ according to the first content display platform set and the second content display platform set, there is no need to traverse the content display platforms accessed by the access user Pₘ and the access user Pₙ, thus reducing the complexity of calculating the similarity between access users, and shortening the duration for calculating the access user overlapping degree.

In some embodiments, the second similarity may be expressed by the following formula (2).

$$F 2 = \frac{R ⋂ S}{R ⋃ S} \qquad ( 2 )$$

In the formula (2), R and S respectively represent the first content display platform set and the second content display platform set, R∩S represents the intersection of the first content display platform set and the second content display platform set, R∪S represents the union of the first content display platform set and the second content display platform set, and F2 represents the second similarity.

For example, the target content display platform is the content display platform K₁ in FIG. 1, the access users belonging to the content display platform K₁ include the user 1 and the user 2, the content display platforms accessed by the user 1 include the content display platform K₁ and the content display platform K₂, and the content display platforms accessed by the user 2 include the content display platform K₁, the content display platform K₂, and the content display platform K₃. It is assumed that the user 1 corresponds to the first content display platform set and the first candidate content display platform set, the first content display platform set is R, and the first candidate content display platform set is R*; and the user 2 corresponds to the second content display platform set and the second candidate content display platform set, the second content display platform set is S, and the second candidate content display platform set is S*.

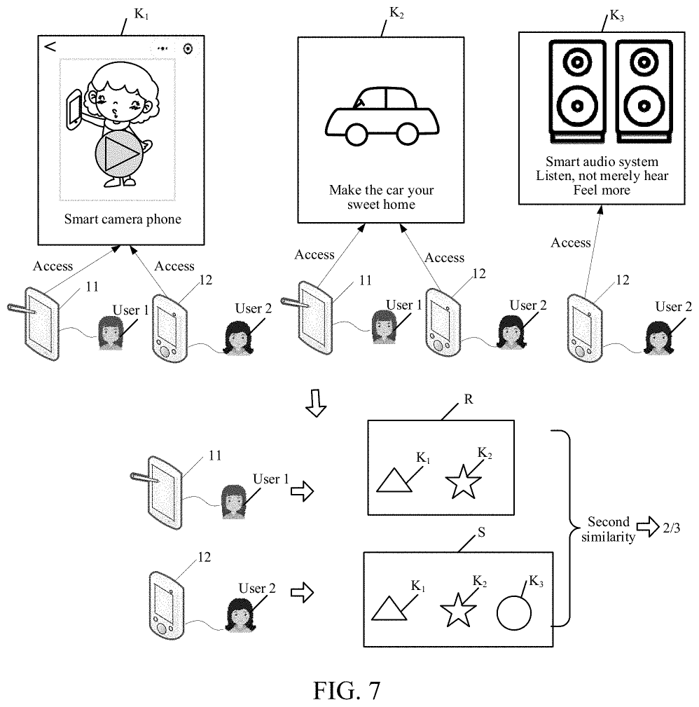

As shown in FIG. 7, when the content display platforms are acquired by the direct acquisition method, the computing device may regard the content display platforms accessed by the user 1 as the first content display platform set, and the content display platforms accessed by the user 2 as the second content display platform set. The first content display platform set R is (K₁, K₂), and the second content display platform set S is (K₁, K₂, K₃). In FIG. 7, the triangle represents the content display platform K₁, the pentagram represents the content display platform K₂, and the circle represents the content display platform K₃. R∩S is (K₁, K₂), and R∪S is (K₁, K₂, k₃). Therefore, the second similarity may be 2/3 calculated by using the above formula (2).

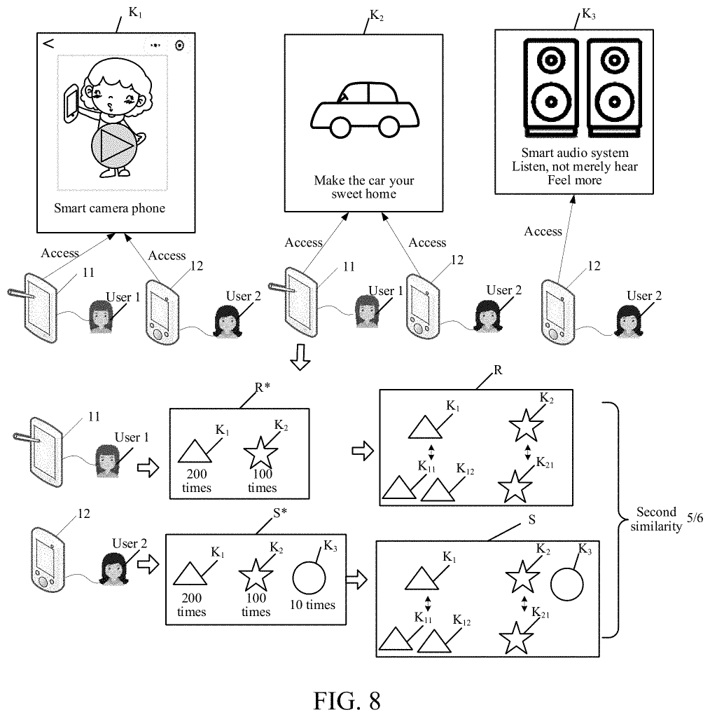

As shown in FIG. 8, when the content display platforms are acquired by the direct acquisition method, the computer device may regard the content display platforms accessed by the user 1 as the first candidate content display platform set, and the first candidate content display platform set R* is (K₁, K₂); and regard the content display platforms accessed by the user 2 as the second candidate content display platform set, and the second candidate content display platform set S* is (K₁, K₂, K₃). The number of accesses of the user 1 to the content display platforms in the first candidate content display platform set may be acquired from the access behavior data, and the number of accesses of the user 2 to the content display platforms in the second candidate content display platform set may be acquired from the access behavior data. As shown in Table 2, the numbers of accesses of the user 1 to K₁ and K₂ are 200 and 100 respectively, and the numbers of accesses of the user 2 to K₁, K₂, and K₃ are 200, 100, and 10, respectively.

As shown in FIG. 8, after acquiring the numbers of accesses of the access users to the content display platforms, the computer device may generate the first virtual content display platform corresponding to the content display platform K₁ according to the number of accesses of the user 1 to the content display platform K₁, that is, the first virtual content display platform corresponding to the content display platform K₁ includes: K₁₁ and K₁₂. The first virtual content display platform corresponding to the content display platform K₂ may be generated according to the number of accesses of the user 1 to the content display platform K₁, that is, the first virtual content display platform corresponding to the content display platform K₂ includes: K₂₁. Likewise, the second virtual content display platform corresponding to the content display platform K₁ may be generated according to the number of accesses of the user 2 to the content display platform K₁, that is, the second virtual content display platform corresponding to the content display platform K₁ includes: K₁₁ and K₁₂. The second virtual content display platform corresponding to the content display platform K₂ may be generated according to the number of accesses of the user 2 to the content display platform K₂, that is, the second virtual content display platform corresponding to the content display platform K₂ includes: K₂₁. According to the fact that the number of accesses of the user 2 to the content display platform K₃ is relatively small, the second virtual content display platform corresponding to the content display platform K₃ may not be generated.

After acquiring the first virtual content display platforms and the second virtual content display platforms, the computer device may add the first virtual content display platforms to the first candidate content display platform set to obtain the first content display platform set, and the first content display platform set R is (K₁, K₁₁, K₁₂, K₂, K₂₁); and may add the second virtual content display platforms to the second candidate content display platform set to obtain the second content display platform set, and the second content display platform set S is (K₁, K₁₁, K₁₂, K₂, K₂₁, K₃). R∩S is (K₁, K₁₂, K₂, K₂₁), and R∪S is (K₁, K₁₁, K₁₂, K₂, K₂₁, K₃). Therefore, the second similarity may be 5/6 calculated by using the above formula (2).

TABLE 2

| | |
|---|---|
| User 1 | The number of accesses to K₁ is 200 |
| | The number of accesses to K₂ is 100 |
| User 2 | The number of accesses to K₁ is 200 |
| | The number of accesses to K₂ is 100 |
| | The number of accesses to K₃ is 10 |

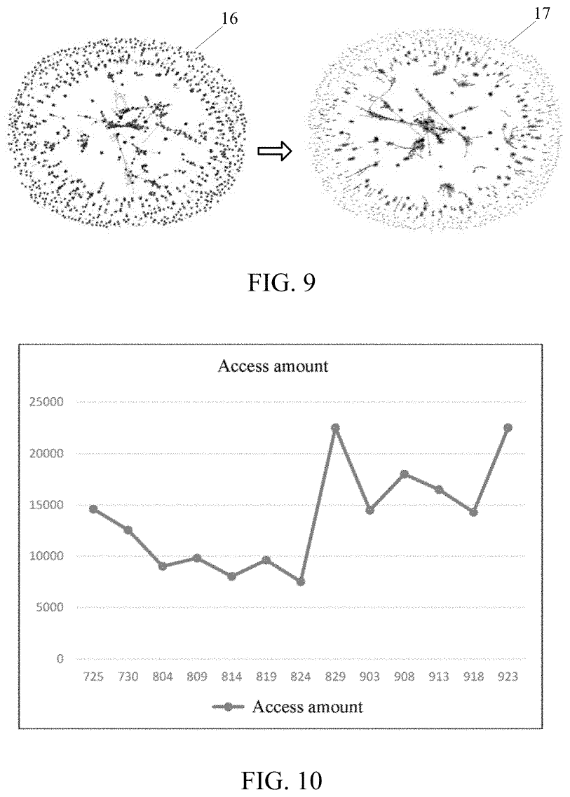

In some embodiments, as shown in FIG. 9, the computer device visualizes the content display platforms accessed by the abnormal users to obtain a visualized content display platform 16 and a visualized content display platform 17. Dots in the visualized content display platform 16 and the visualized content display platform 17 represent content display platforms. The visualized content display platform 16 includes the content display platforms accessed by the abnormal access users, and the virtual content display platforms generated according to the number of accesses; and the visualized content display platform 17 is obtained by merging the content display platforms and the corresponding virtual content display platforms, that is, the visualized content display platform 17 includes the content display platforms accessed by the abnormal access users. As can be seen according to FIG. 9, abnormal access users usually access a large number of content display platforms.

In some embodiments, the access behavior data includes institutions to which the access users belong. Step S104 may include the following steps s111 to s113.

Step s111: Determine access users belonging to a target institution from the access users belonging to the target content display platforms according to the access behavior data.

Step s112: Acquire the quantity of access users belonging to the target institution.

Step s113: Determine the access users belonging to the target institution as abnormal access users when the quantity of access users belonging to the target institution is greater than a third quantity threshold.

In steps s111 to s113, the computer device may determine the access users belonging to the target institution from the access users belonging to the target content display platforms according to the access behavior data. The target institution may refer to an institution that is marked as abnormal, or the target institution may refer to any institution in the institutions corresponding to the access users belonging to the target content display platforms. The quantity of access users belonging to the target institution is acquired. When the quantity of access users belonging to the target institution is less than or equal to the third quantity threshold, the quantity of access users belonging to the target institution is relatively small. Therefore, the probability of abnormal behaviors in the target institution is relatively low, and there is no need to regard the access users belonging to the target institution as abnormal access users. When the quantity of access users belonging to the target institution is greater than the third quantity threshold, it indicates that the target institution has behaviors for the purpose of acquiring access amount, that is, the target institution has cheating behaviors for increasing the access amount, and the access users belonging to the target institution are determined as abnormal access users.

In some embodiments, the computer device may acquire access amounts (i.e., the numbers of accesses) belonging to the target access users, determine access amount change rates of the access users according to the access amounts, and determine abnormal access users according to the access amount change rates. It is assumed that the user 1 belongs to the target content display platform, and daily access amounts of the user 1 from July 25 to September 23 are shown in FIG. 10. As can be seen from FIG. 10, the access amounts from July 25 to September 23 have a growing trend, that is, the access amount change rate increases continuously, and the access amount on September 23 has increased by nearly 10,000 compared with that on July 25. Therefore, it can be determined that the user 1 is an abnormal access user.

For example, as shown in Table 3 below, the target content display platform includes the user 1, the user 2, a user 3, a user 4, the user 5, and the like. The user 1, the user 3, the user 4, and the user 5 belong to an institution 1, and the user 2 belongs to an institution 2. It is assumed that the third quantity threshold is 80,000, the quantity of users belonging to the institution 1 is 100,000, and the quantity of users belonging to the institution 2 is 10,000. The quantity of users of the institution 1 is greater than that of the institution 2; therefore, the institution 1 may be regarded as the target institution, and the quantity of users of the target institution is greater than the third quantity threshold, so the access users belonging to the target institution are determined as abnormal users.

TABLE 3

| | |
|---|---|
| User 1 | Institution 1 |
| User 2 | Institution 2 |
| User 3 | Institution 1 |
| User 4 | Institution 1 |
| User 5 | Institution 1 |
| . . . | . . . |

In an embodiment, the access behavior data includes access durations to the business contents provided by the target content display platforms. Step S104 may include the following steps s211 to s212.

Step s211: Acquire login durations of the access users belonging to the target content display platforms on the target content display platforms.

Step s212: Regard access users who belong to the target content display platforms and whose differences between the access durations and the login durations are less than a duration threshold as abnormal access users. In other words, abnormal access users are determined according to the login durations and the access durations. An abnormal user is an access user that belongs to the target content display platforms and a difference between the access duration and the login duration of whom is less than a duration threshold.

In steps s211 to s212, the computer device may acquire the login durations of the access users belonging to the target content display platforms on the target content display platforms, and the differences between the access durations of the access users and the login durations are less than the duration threshold, indicating that the purpose of the access users logging in to the target content display platforms is to access the business contents provided on the target content display platforms, that is, there are the access users for increasing the access amounts of the business contents of the target content display platforms. The access users who belong to the target content display platforms and whose differences between the access durations and the login durations are less than the duration threshold may be determined as abnormal access users. For example, the target content display platform is a social application, and a login duration for a user to log in to the social application is 5 days. The user has accessed a business content of recommending a game application on the social application every day during the 5 days, that is, the access duration of the user to the business content of the social application is 5 days. It can be determined that the purpose of the user logging in to the social application is to access the business content on the social application, that is, the user is determined an abnormal user.

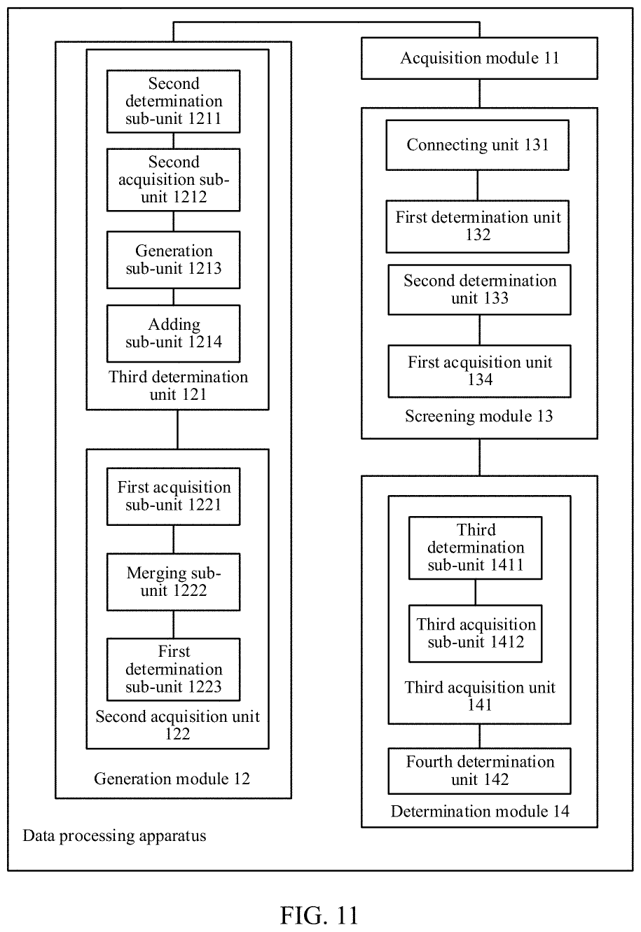

FIG. 11 is a schematic structural diagram of a data processing apparatus according to an embodiment of the present disclosure. The data processing apparatus may be a computer program (including program code) running in a computer device. For example, the data processing apparatus is application software. The apparatus may be configured to perform corresponding steps in the method provided in the embodiments of the present disclosure. As shown in FIG. 11, the data processing apparatus may include:

An acquisition module 11 configured to acquire access users associated with at least two content display platforms, the at least two content display platforms being configured to provide business contents to the access users;

a generation module 12 configured to generate access user overlapping degrees between pairs of content display platforms in the at least two content display platforms according to the access users;

a screening module 13 configured to determine abnormally accessed content display platforms from the at least two content display platforms according to the access user overlapping degrees and regard them as target content display platforms; and

a determination module 14 configured to determine abnormal access users from access users belonging to the target content display platforms.

The screening module 13 includes:

A connecting unit 131 configured to determine the at least two content display platforms as at least two nodes, and connect two nodes, in the at least two nodes, whose access user overlapping degree is greater than a first overlapping threshold to obtain a platform network graph including the at least two nodes; and

a first determination unit 132 configured to, when a complete subgraph is included in the platform network graph, and the quantity of nodes in the complete subgraph is greater than a first quantity threshold, regard two nodes, in the complete subgraph, whose access user overlapping degree is greater than a second overlapping threshold as the target content display platforms.

The screening module 13 includes:

A second determination unit 133 configured to determine, from the at least two content display platforms, a content display platform whose access user overlapping degree with a first content display platform is greater than a third overlapping threshold as a second content display platform, the first content display platform belonging to the at least two content display platforms; and

a first acquisition unit 134 configured to acquire the quantity of the second content display platforms;

the second determination unit 133 being further configured to regard the first content display platform as the target content display platform when the quantity of the second content display platforms is greater than a second quantity threshold.

In some embodiments, the at least two content display platforms include a content display platform Kᵢ and a content display platform Kⱼ, both i and j are positive integers less than or equal to N, and N is the quantity of content display platforms of the at least two content display platforms. The generation module 12 includes:

A third determination unit 121 configured to regard access users belonging to the content display platform Kᵢ as a first access user set, and regard access users belonging to the content display platform Kⱼ as a second access user set; and

a second acquisition unit 122 configured to acquire a similarity between the first access user set and the second access user set and regard it as a first similarity;

the third determination unit 121 being further configured to determine an access user overlapping degree between the content display platform Kᵢ and the content display platform Kⱼ according to the first similarity.

The second acquisition unit 122 includes:

A first acquisition sub-unit 1221 configured to acquire access users having identical user identifications in the first access user set and the second access user set and regard them as an overlapping access user set; and

a merging sub-unit 1222 configured to merge the first access user set and the second access user set to obtain a merged access user set; and

a first determination sub-unit 1223 configured to regard a ratio of the overlapping access user set to the merged access user set as the first similarity.

In some embodiments, the third determination unit 121 includes:

A second determination sub-unit 1211 configured to regard access users belonging to the content display platform Kᵢ as a first candidate access user set; and regard access users belonging to the content display platform Kⱼ as a second candidate access user set;

a second acquisition sub-unit 1212 configured to acquire the number of accesses to the content display platform Kᵢ by the access users belonging to the content display platform Kᵢ as a first number of accesses, and acquire the number of accesses to the content display platform Kⱼ by the access users belonging to the content display platform Kⱼ as a second number of accesses;

a generation sub-unit 1213 configured to generate virtual access users corresponding to the access users belonging to the content display platform Kᵢ according to the first number of accesses and regard them as first virtual access users, the quantity of the first virtual access users having a positive correlation relationship with the first number of accesses; generate virtual access users corresponding to the access users belonging to the content display platform Kⱼ according to the second number of accesses and regard them as second virtual access users, the quantity of the second virtual access users having a positive correlation relationship with the second number of accesses; and

an adding sub-unit 1214 configured to add the first virtual access users to the first candidate access user set to obtain the first access user set, and add the second virtual access users to the second candidate access user set to obtain the second access user set.

The determination module 14 includes:

A third acquisition unit 141 configured to acquire access behavior data of the access users belonging to the target content display platforms; and

a fourth determination unit 142 configured to determine abnormal access users from the access users belonging to the target content display platforms according to the access behavior data.

In some embodiments, an access user Pₘ and an access user Pₙ belong to the target content display platforms, m and n are both positive integers less than or equal to T, T is the quantity of access users belonging to the target content display platforms, and the access behavior data includes accessed content display platforms.

In some embodiments, the third acquisition unit 141 includes:

A third determination sub-unit 1411 configured to regard content display platforms accessed by the access user Pₘ as a first content display platform set, and regard content display platforms accessed by the access user Pₙ as a second content display platform set.

In some embodiments, an access user Pₘ and an access user Pₙ belong to the target content display platforms, m and n are both positive integers less than or equal to T, T is the quantity of access users belonging to the target content display platforms, and the access behavior data includes accessed content display platforms.

In some embodiments, the third acquisition unit 141 includes:

A third determination sub-unit 1411 configured to regard content display platforms accessed by the access user Pₘ as a first content display platform set, and regard content display platforms accessed by the access user Pₙ as a second content display platform set; and

a third acquisition sub-unit 1412 configured to acquire a similarity between the first content display platform set and the second content display platform set and regard it as a second similarity;

the third determination sub-unit 1411 being configured to regard the access user Pₘ and the access user Pₙ as abnormal access users when the second similarity degree is greater than a similarity threshold.

The third acquisition sub-unit 1412 is configured to acquire content display platforms having identical platform identification in the first content display platform set and the second content display platform set and regard them as an overlapping content display platform set; merge the first content display platform set and the second content display platform set to obtain a merged content display platform set; and regard a ratio of the overlapping content display platform set to the merged content display platform set as the second similarity.

The third determination sub-unit 1411 is configured to regard the content display platforms accessed by the access user Pₘ as the first candidate content display platform set, and regard the content display platforms accessed by the access user Pₙ as the second candidate content display platform set; acquire the number of accesses by the access user Pₘ to the content display platforms in the first candidate content display platform set and regard it as a third number of accesses; acquire the number of accesses by the access user Pₙ to the content display platforms in the second candidate content display platform set and regard it as a fourth number of accesses; generate, according to the third number of accesses, virtual content display platforms corresponding to the content display platforms in the first candidate content display platform set and regard them as first virtual content display platforms, the quantity of the first virtual content display platforms having a positive correlation relationship with the third number of accesses; generate, according to the fourth number of accesses, virtual content display platforms corresponding to the content display platforms in the second candidate content display platform set and regard them as second virtual content display platforms, the quantity of the second virtual content display platforms having a positive correlation relationship with the fourth number of accesses; add the first virtual content display platforms to the first candidate content display platform set to obtain the first content display platform set; and add the second virtual content display platforms to the second candidate content display platform set to obtain the second content display platform set.

In some embodiments, the access behavior data includes institutions to which the access users belong. the determination module 14 is configured to determine access users belonging to a target institution from the access users belonging to the target content display platforms according to the access behavior data; acquire the quantity of access users belonging to the target institution; and determine the access users belonging to the target institution as abnormal access users when the quantity of access users belonging to the target institution is greater than a third quantity threshold.

In some embodiments, the access behavior data includes access durations to the business contents provided by the target content display platforms; and the determination module 14 is configured to acquire login durations of the access users belonging to the target content display platforms on the target content display platforms; and determine access users who belong to the target content display platforms and whose differences between the access durations and the login durations are less than a duration threshold as abnormal access users.

It is to be understood that the data processing apparatus described in this embodiment of the present disclosure can perform the description of the above data processing method in the embodiment corresponding to FIG. 3 in the foregoing, and the description of the beneficial effects of using the same method will not be repeated.

The term unit (and other similar terms such as subunit, module, submodule, etc.) in this disclosure may refer to a software unit, a hardware unit, or a combination thereof. A software unit (e.g., computer program) may be developed using a computer programming language. A hardware unit may be implemented using processing circuitry and/or memory. Each unit can be implemented using one or more processors (or processors and memory). Likewise, a processor (or processors and memory) can be used to implement one or more units. Moreover, each unit can be part of an overall unit that includes the functionalities of the unit.

In the embodiments of the present disclosure, a computer device may acquire access users associated with at least two content display platforms, and generate access user overlapping degrees between pairs of content display platforms in the at least two content display platforms according to the access users. The access user overlapping degree can reflect identical access users accessing multiple content display platforms. Therefore, abnormally accessed content display platforms may be determined from the at least two content display platforms based on the access user overlapping degree and regarded as target content display platforms. That is, target content display platforms that gather abnormal access users can be identified by the access user overlapping degree. In addition, abnormal access users are determined from access users belonging to the target content display platforms, that is, abnormal access users are identified by analyzing access data and access users of the content display platforms, and thus the accuracy of identifying abnormal access users can be improved. Moreover, it is unnecessary to analyze all access users belonging to at least two content display platforms, which can improve the efficiency of identifying abnormal access users and reduce the complexity of identifying abnormal access users. In addition, abnormal access users in content display platforms can be quickly identified by the access user overlapping degree between the content display platforms, which can avoid the problem of network congestion caused by abnormal access users, and improve the promotion effect of commodities or services. Promotion expenses of products or services of merchants can be reduced, and the accuracy of evaluating the promotion effect can be increased.

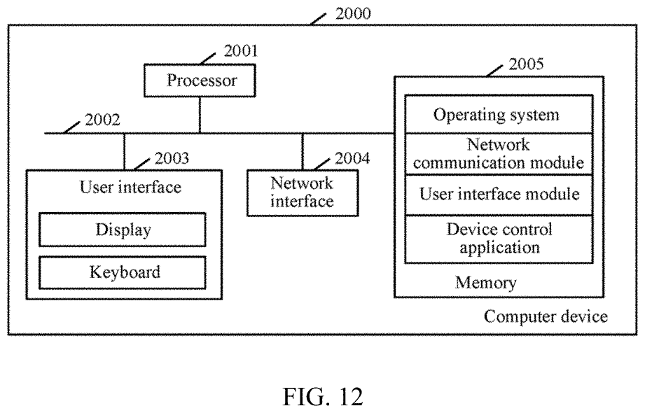

FIG. 12 is a schematic structural diagram of another computer device according to an embodiment of the present disclosure. As shown in FIG. 12, the computer device 2000 may include: a processor 2001, a network interface 2004, and a memory 2005, as well as a user interface 2003 and at least one communication bus 2002. The communication bus 2002 is configured to implement connection communication between the components. The user interface 2003 may include a display, a keyboard, and optionally, the user interface 2003 may further include a standard wired interface and a standard wireless interface. Optionally, the network interface 2004 may include a standard wired interface and a standard wireless interface (such as a Wi-Fi interface). The memory 2005 may be a high-speed random access memory (RAM), or may be a non-volatile memory, for example, at least one magnetic disk memory. Optionally, the memory 2005 may be further at least one storage apparatus away from the processor 2001. As shown in FIG. 12, the memory 2005 used as a computer-readable storage medium may include an operating system, a network communication module, a user interface module, and a device-control application program.

In the computer device 2000 shown in FIG. 12, the network interface 2004 may provide a network communication function, the user interface 2003 is mainly configured to provide an input interface for a user, and the processor 2001 may be configured to call the device control application stored in the memory 2005 to implement:

acquiring access users associated with at least two content display platforms, the at least two content display platforms being configured to provide business contents to the access users;

generating access user overlapping degrees between pairs of content display platforms in the at least two content display platforms according to the access users;

determining out abnormally accessed content display platforms from the at least two content display platforms according to the access user overlapping degrees and regarding the determined abnormally accessed content display platforms; and

determining abnormal access users from access users belonging to the target content display platforms.

In some embodiments, the processor 2001 may be configured to call the device control application program stored in the memory 2005 to implement:

determining the at least two content display platforms as at least two nodes, and connecting two nodes, in the at least two nodes, whose access user overlapping degree is greater than a first overlapping threshold to obtain a platform network graph including the at least two nodes; and

when a complete subgraph is included in the platform network graph, and the quantity of nodes in the complete subgraph is greater than a first quantity threshold, regarding two nodes, in the complete subgraph, whose access user overlapping degree is greater than a second overlapping threshold as the target content display platforms.

In some embodiments, the processor 2001 may be configured to call the device control application program stored in the memory 2005 to implement:

determining, from the at least two content display platforms, a content display platform whose access user overlapping degree with a first content display platform is greater than a third overlapping threshold as a second content display platform, the first content display platform belonging to the at least two content display platforms; and

acquiring the quantity of the second content display platforms; and

regarding the first content display platform as the target content display platform when the quantity of the second content display platforms is greater than a second quantity threshold.

In some embodiments, the at least two content display platforms include a content display platform Kᵢ and a content display platform Kⱼ, both i and j are positive integers less than or equal to N, and N is the quantity of content display platforms of the at least two content display platforms. In some embodiments, the processor 2001 may be configured to call the device control application stored in the memory 2005 to implement:

regarding access users belonging to the content display platform Kᵢ as a first access user set, and regarding access users belonging to the content display platform Kⱼ as a second access user set;

acquiring a similarity between the first access user set and the second access user set and regarding it as a first similarity;

determining an access user overlapping degree between the content display platform Kᵢ and the content display platform Kⱼ according to the first similarity.

In some embodiments, the processor 2001 may be configured to call the device control application program stored in the memory 2005 to implement:

acquiring access users having identical user identifications in the first access user set and the second access user set and regarding them as an overlapping access user set;

merging the first access user set and the second access user set to obtain a merged access user set; and

regarding a ratio of the overlapping access user set to the merged access user set as the first similarity.

In some embodiments, the processor 2001 may be configured to call the device control application program stored in the memory 2005 to implement:

regarding access users belonging to the content display platform Kᵢ as a first candidate access user set;

regarding access users belonging to the content display platform Kⱼ as a second candidate access user set;

acquiring the number of accesses to the content display platform Kᵢ by the access users belonging to the content display platform Kᵢ and regarding it as a first number of accesses, and acquiring the number of accesses to the content display platform Kⱼ by the access users belonging to the content display platform Kⱼ and regarding it as a second number of accesses;

generating virtual access users corresponding to the access users belonging to the content display platform Kᵢ according to the first number of accesses and regarding them as first virtual access users, the quantity of the first virtual access users having a positive correlation relationship with the first number of accesses;

generating virtual access users corresponding to the access users belonging to the content display platform Kⱼ according to the second number of accesses and regarding them as second virtual access users, the quantity of the second virtual access users having a positive correlation relationship with the second number of accesses; and

adding the first virtual access users to the first candidate access user set to obtain the first access user set, and adding the second virtual access users to the second candidate access user set to obtain the second access user set.

In some embodiments, the processor 2001 may be configured to call the device control application program stored in the memory 2005 to implement:

acquiring access behavior data of the access users belonging to the target content display platforms; and

determining abnormal access users from the access users belonging to the target content display platforms according to the access behavior data.

In some embodiments, an access user Pₘ and an access user Pₙ belong to the target content display platforms, m and n are both positive integers less than or equal to T, T is the quantity of access users belonging to the target content display platforms, and the access behavior data includes accessed content display platforms.

In some embodiments, the processor 2001 may be configured to call the device control application program stored in the memory 2005 to implement:

regarding content display platforms accessed by the access user Pₘ as a first content display platform set, and regarding content display platforms accessed by the access user Pₙ as a second content display platform set;

acquiring a similarity between the first content display platform set and the second content display platform set and regarding it as a second similarity; and

regarding the access user Pₘ and the access user Pₙ as abnormal access users when the second similarity degree is greater than a similarity threshold.

In some embodiments, the processor 2001 may be configured to call the device control application program stored in the memory 2005 to implement:

acquiring content display platforms having identical platform identifications in the first content display platform set and the second content display platform set and regarding them as an overlapping content display platform set;

merging the first content display platform set and the second content display platform set to obtain a merged content display platform set; and

regarding a ratio of the overlapping content display platform set to the merged content display platform set as the second similarity.

In some embodiments, the processor 2001 may be configured to call the device control application program stored in the memory 2005 to implement:

regarding content display platforms accessed by the access user Pₘ as the first candidate content display platform set, and regarding content display platforms accessed by the access user Pₙ as the second candidate content display platform set;

acquiring the number of accesses by the access user Pₘ to the content display platforms in the first candidate content display platform set and regarding it as a third number of accesses; acquiring the number of accesses by the access user Pₙ to the content display platforms in the second candidate content display platform set and regarding it as a fourth number of accesses;

generating, according to the third number of accesses, virtual content display platforms corresponding to the content display platforms in the first candidate content display platform set and regarding them as first virtual content display platforms, the quantity of the first virtual content display platforms having a positive correlation relationship with the third number of accesses;

generating, according to the fourth number of accesses, virtual content display platforms corresponding to the content display platforms in the second candidate content display platform set and regarding them as second virtual content display platforms, the quantity of the second virtual content display platforms having a positive correlation relationship with the fourth number of accesses;

adding the first virtual content display platforms to the first candidate content display platform set to obtain the first content display platform set; and adding the second virtual content display platforms to the second candidate content display platform set to obtain the second content display platform set.

In some embodiments, the processor 2001 may be configured to call the device control application program stored in the memory 2005 to implement:

determining access users belonging to a target institution from the access users belonging to the target content display platforms according to the access behavior data;

acquiring the quantity of access users belonging to the target institution; and

determining the access users belonging to the target institution as abnormal access users when the quantity of access users belonging to the target institution is greater than a third quantity threshold.

In some embodiments, the processor 2001 may be configured to call the device control application program stored in the memory 2005 to implement:

acquiring login durations of the access users belonging to the target content display platforms on the target content display platforms; and

determining access users who belong to the target content display platforms and whose differences between the access durations and the login durations are less than a duration threshold as abnormal access users.

It is to be understood that the computer device 2000 described in this embodiment of the present disclosure can implement the descriptions of the data processing method in the foregoing embodiment corresponding to FIG. 3, and can also implement the descriptions of the data processing apparatus in the foregoing embodiment corresponding to FIG. 11. Details are not described herein again. In addition, the description of beneficial effects of the same method are not described herein again.

In the embodiments of the present disclosure, a computer device may acquire access users associated with at least two content display platforms, and generate access user overlapping degrees between pairs of content display platforms in the at least two content display platforms according to the access users. The access user overlapping degree can reflect identical access users accessing multiple content display platforms. Therefore, abnormally accessed content display platforms may be screened out from the at least two content display platforms based on the access user overlapping degree and regarded as target content display platforms. That is, target content display platforms that gather abnormal access users can be identified by the access user overlapping degree. In addition, abnormal access users are determined from access users belonging to the target content display platforms, that is, abnormal access users are identified by analyzing access data and access users of the content display platforms, and thus the accuracy of identifying abnormal access users can be improved. Moreover, it is unnecessary to analyze all access users belonging to at least two content display platforms, which can improve the efficiency of identifying abnormal access users and reduce the complexity of identifying abnormal access users. In addition, abnormal access users in content display platforms can be quickly identified by the access user overlapping degree between the content display platforms, which can avoid the problem of network congestion caused by abnormal access users, and improve the promotion effect of commodities or services. Promotion expenses of products or services of merchants can be reduced, and the accuracy of evaluating the promotion effect can be increased.

In addition, the embodiments of the present disclosure further provide a computer-readable storage medium. The computer-readable storage medium stores a computer program executed by the data processing apparatus 1 mentioned above, and the computer program includes program instructions. When executing the program instructions, the processor can perform the descriptions of the data processing method in the foregoing embodiment corresponding to FIG. 3. Therefore, details are not described herein again. In addition, the description of beneficial effects of the same method are not described herein again. For technical details that are not disclosed in the embodiments of the computer-readable storage medium of the present disclosure, refer to the method embodiments of the present disclosure. In an example, the program instructions may be deployed to be executed on a computing device, or deployed to be executed on a plurality of computing devices at the same location, or deployed to be executed on a plurality of computing devices that are distributed in a plurality of locations and interconnected by using a communication network, where the plurality of computing devices distributed in a plurality of locations and interconnected by using a communication network may form a blockchain system.

A person of ordinary skill in the art may understand that all or some of the processes of the methods in the embodiments may be implemented by a computer program instructing relevant hardware. The program may be stored in a computer-readable storage medium. When the program is executed, the procedures of the foregoing method embodiments are performed. The foregoing storage medium may include a magnetic disc, an optical disc, a read-only memory (ROM), a random access memory (RAM), or the like.

What is disclosed above is merely exemplary embodiments of the present disclosure, and certainly is not intended to limit the scope of the claims of the present disclosure. Therefore, equivalent variations made in accordance with the claims of the present disclosure shall fall within the scope of the present disclosure.

What is claimed is:

1. A data processing method, applied to a computing device of a first platform, the first platform providing at least two content display platforms, and the method comprising:
acquiring access users associated with the at least two content display platforms, the at least two content display platforms being configured to provide business contents to the access users;
generating access user overlapping degrees between pairs of content display platforms in the at least two content display platforms according to the access users;
determining abnormally accessed content display platforms from the at least two content display platforms according to the access user overlapping degrees, and regarding the determined abnormally accessed content display platforms as target content display platforms; and
determining abnormal access users from target access users belonging to the target content display platforms.

2. The method of claim 1, wherein the determining abnormally accessed content display platforms comprises:
determining the at least two content display platforms as at least two nodes, and connecting two nodes, in the at least two nodes, whose access user overlapping degree is greater than a first overlapping threshold to obtain a platform network graph comprising the at least two nodes; and
when a complete subgraph is comprised in the platform network graph, and a quantity of nodes in the complete subgraph is greater than a first quantity threshold, regarding two nodes, in the complete subgraph, whose access user overlapping degree is greater than a second overlapping threshold as the target content display platforms.

3. The method of claim 1, wherein the determining abnormally accessed content display platforms comprises:
determining, from the at least two content display platforms, a content display platform whose access user overlapping degree with a first content display platform is greater than a third overlapping threshold as a second content display platform, the first content display platform belonging to the at least two content display platforms; and
acquiring a quantity of the second content display platforms;
regarding the first content display platform as one of the target content display platforms when the quantity of the second content display platforms is greater than a second quantity threshold.

4. The method of claim 1, wherein the at least two content display platforms comprise a content display platform Ki and a content display platform Kj, both i and j are positive integers less than or equal to N, and N is a quantity of content display platforms of the at least two content display platforms; the generating access user overlapping degrees between pairs of content display platforms in the at least two content display platforms according to the access users comprises:
regarding access users belonging to the content display platform Ki as a first access user set, and regarding access users belonging to the content display platform Kj as a second access user set;
acquiring a first similarity between the first access user set and the second access user set; and
determining an access user overlapping degree between the content display platform Ki and the content display platform Kj according to the first similarity.

5. The method of claim 4, wherein the acquiring a first similarity between the first access user set and the second access user set comprises:
acquiring access users having identical user identifications in the first access user set and the second access user set and regarding the acquired access users as an overlapping access user set;
merging the first access user set and the second access user set to obtain a merged access user set; and
regarding a ratio of the overlapping access user set to the merged access user set as the first similarity.

6. The method of claim 4, wherein the regarding access users belonging to the content display platform Ki as a first access user set, and regarding access users belonging to the content display platform Kj as a second access user set comprises:
regarding access users belonging to the content display platform Ki as a first candidate access user set;
regarding access users belonging to the content display platform Kj as a second candidate access user set;
acquiring a first number of accesses to the content display platform Ki by the access users belonging to the content display platform Ki, and acquiring a second number of accesses to the content display platform Kj by the access users belonging to the content display platform Kj;
generating first virtual access users corresponding to the access users belonging to the content display platform Ki according to the first number of accesses, a quantity of the first virtual access users having a positive correlation relationship with the first number of accesses;
generating second virtual access users corresponding to the access users belonging to the content display platform Kj according to the second number of accesses, a quantity of the second virtual access users having a positive correlation relationship with the second number of accesses; and
adding the first virtual access users to the first candidate access user set to obtain the first access user set, and adding the second virtual access users to the second candidate access user set to obtain the second access user set.

7. The method of claim 1, wherein the determining abnormal access users from target access users belonging to the target content display platforms comprises:
acquiring access behavior data of the target access users belonging to the target content display platforms; and
determining the abnormal access users from the target access users belonging to the target content display platforms according to the access behavior data.

8. The method of claim 7, wherein an access user Pm and an access user Pn belong to the target content display platforms, m and n are both positive integers less than or equal to T, T is a quantity of the target access users belonging to the target content display platforms, and the access behavior data comprises accessed content display platforms;
the determining abnormal access users from target access users belonging to the target content display platforms comprises:
regarding content display platforms accessed by the access user Pm as a first content display platform set, and regarding content display platforms accessed by the access user Pn as a second content display platform set;
acquiring a second similarity between the first content display platform set and the second content display platform set; and
regarding the access user Pm and the access user Pn as abnormal access users when the second similarity is greater than a similarity threshold.

9. The method of claim 8, wherein the acquiring a second similarity between the first content display platform set and the second content display platform set comprises:
acquiring content display platforms having identical platform identifications in the first content display platform set and the second content display platform set and regarding the acquired content display platforms as an overlapping content display platform set;
merging the first content display platform set and the second content display platform set to obtain a merged content display platform set; and
regarding a ratio of the overlapping content display platform set to the merged content display platform set as the second similarity.

10. The method of claim 8, wherein the regarding content display platforms accessed by the access user Pm as a first content display platform set, and regarding content display platforms accessed by the access user Pn as a second content display platform set comprises:
regarding content display platforms accessed by the access user Pm as a first candidate content display platform set, and regarding content display platforms accessed by the access user Pn as a second candidate content display platform set;
acquiring a third number of accesses by the access user Pm to the content display platforms in the first candidate content display platform set; acquiring a fourth number of accesses by the access user Pn to the content display platforms in the second candidate content display platform set;
generating, according to the third number of accesses, first virtual content display platforms corresponding to the content display platforms in the first candidate content display platform set and regarding them, a quantity of the first virtual content display platforms having a positive correlation relationship with the third number of accesses;
generating, according to the fourth number of accesses, second virtual content display platforms corresponding to the content display platforms in the second candidate content display platform set, a quantity of the second virtual content display platforms having a positive correlation relationship with the fourth number of accesses;
adding the first virtual content display platforms to the first candidate content display platform set to obtain first content display platform set; and adding the second virtual content display platform to the second candidate content display platform set to obtain the second content display platform set.

11. The method of claim 7, wherein the access behavior data comprises institutions to which the access users belong;
the determining abnormal access users from target access users belonging to the target content display platforms comprises:
determining access users belonging to a target institution from the target access users belonging to the target content display platforms according to the access behavior data;
acquiring a quantity of the access users belonging to the target institution; and
determining the access users belonging to the target institution as abnormal access users when the quantity of the access users belonging to the target institution is greater than a third quantity threshold.

12. The method of claim 7, wherein the access behavior data comprises access durations to the business contents provided by the target content display platforms; and
the determining abnormal access users from target access users belonging to the target content display platforms comprises:
acquiring login durations of the access users belonging to the target content display platforms on the target content display platforms; and
determining abnormal access users according to the login durations and the access durations, an abnormal user being an access user that belongs to the target content display platforms and a difference between the access duration and the login duration of whom is less than a duration threshold.

13. A data processing apparatus, belonging to a first platform, the first platform providing at least two content display platforms, the apparatus comprising a memory and a processor, wherein the memory is configured to store program code, and the processor is configured to call the program code to perform:
acquiring access users associated with at least two content display platforms, the at least two content display platforms being configured to provide business contents to the access users;
generating access user overlapping degrees between pairs of content display platforms in the at least two content display platforms according to the access users;
determining abnormally accessed content display platforms from the at least two content display platforms according to the access user overlapping degrees and regarding the determined abnormally accessed content display platforms as target content display platforms; and
determining abnormal access users from target access users belonging to the target content display platforms.

14. The apparatus of claim 13, wherein the determining abnormally accessed content display platforms comprises:
determining the at least two content display platforms as at least two nodes, and connecting two nodes, in the at least two nodes, whose access user overlapping degree is greater than a first overlapping threshold to obtain a platform network graph comprising the at least two nodes; and
when a complete subgraph is comprised in the platform network graph, and a quantity of nodes in the complete subgraph is greater than a first quantity threshold, regarding two nodes, in the complete subgraph, whose access user overlapping degree is greater than a second overlapping threshold as the target content display platforms.

15. The apparatus of claim 13, wherein the determining abnormally accessed content display platforms comprises:
determining, from the at least two content display platforms, a content display platform whose access user overlapping degree with a first content display platform is greater than a third overlapping threshold as a second content display platform, the first content display platform belonging to the at least two content display platforms; and
acquiring a quantity of the second content display platforms;
regarding the first content display platform as one of the target content display platforms when the quantity of the second content display platforms is greater than a second quantity threshold.

16. The apparatus of claim 13, wherein the at least two content display platforms comprise a content display platform Ki and a content display platform Kj, both i and j are positive integers less than or equal to N, and N is a quantity of content display platforms of the at least two content display platforms; the generating access user overlapping degrees between pairs of content display platforms in the at least two content display platforms according to the access users comprises:
regarding access users belonging to the content display platform Ki as a first access user set, and regarding access users belonging to the content display platform Kj as a second access user set;
acquiring a first similarity between the first access user set and the second access user set; and
determining an access user overlapping degree between the content display platform Ki and the content display platform Kj according to the first similarity.

17. The apparatus of claim 16, wherein the acquiring a first similarity between the first access user set and the second access user set comprises:
acquiring access users having identical user identifications in the first access user set and the second access user set and regarding the acquired access users as an overlapping access user set;
merging the first access user set and the second access user set to obtain a merged access user set; and
regarding a ratio of the overlapping access user set to the merged access user set as the first similarity.

18. The apparatus of claim 16, wherein the regarding access users belonging to the content display platform Ki as a first access user set, and regarding access users belonging to the content display platform Kj as a second access user set comprises:
regarding access users belonging to the content display platform Ki as a first candidate access user set;
regarding access users belonging to the content display platform Kj as a second candidate access user set;
acquiring a first number of accesses to the content display platform Ki by the access users belonging to the content display platform Ki, and acquiring a second number of accesses to the content display platform Kj by the access users belonging to the content display platform Kj;
generating first virtual access users corresponding to the access users belonging to the content display platform Ki according to the first number of accesses, a quantity of the first virtual access users having a positive correlation relationship with the first number of accesses;
generating second virtual access users corresponding to the access users belonging to the content display platform Kj according to the second number of accesses, a quantity of the second virtual access users having a positive correlation relationship with the second number of accesses; and
adding the first virtual access users to the first candidate access user set to obtain the first access user set, and adding the second virtual access users to the second candidate access user set to obtain the second access user set.

19. The apparatus of claim 13, wherein the determining abnormal access users from target access users belonging to the target content display platforms comprises:
acquiring access behavior data of the target access users belonging to the target content display platforms; and
determining the abnormal access users from the target access users belonging to the target content display platforms according to the access behavior data.

20. A non-transitory computer-readable storage medium storing a computer program, wherein the computer program comprises program instructions, and the program instructions, when executed by a processor of a first platform providing at least two content display platforms, causing the processor to perform:
acquiring access users associated with the at least two content display platforms, the at least two content display platforms being configured to provide business contents to the access users;
generating access user overlapping degrees between pairs of content display platforms in the at least two content display platforms according to the access users;
determining abnormally accessed content display platforms from the at least two content display platforms according to the access user overlapping degrees, and regarding the determined abnormally accessed content display platforms as target content display platforms; and
determining abnormal access users from target access users belonging to the target content display platforms.
